(19) United States
(12) Patent Application Publication
(10) Pub. No.: US 2018/0217680 A1
(43) Pub. Date: Aug. 2, 2018

(54) WEARABLE DEVICE, CONTROL METHOD, AND CONTROL CODE

(71) Applicant: KYOCERA Corporation, Kyoto-shi, Kyoto (JP)

(72) Inventors: Tomohiro SUDOU, Yokohama-shi, Kanagawa (JP); Saya MIURA, Yokohama-shi, Kanagawa (JP)

(21) Appl. No.: 15/747,754

(22) PCT Filed: Jul. 26, 2016
(86) PCT No.: PCT/JP2016/071936

§ 371 Date: Jan. 25, 2018

(30) Foreign Application Priority Data
Jul. 29, 2015 (JP) 2015-149242

(51) Int. Cl. G06F 3/0346; G06F 3/0481

(52) U.S. Cl. CPC G06F 3/0346; G06F 3/0481

(57) ABSTRACT

A wearable device according to the present application includes a detector and a controller. The detector can detect an upper limb of a user existing in a real space. The controller executes a predetermined process based on detection of a rotating body motion accompanying rotation of an arm in the upper limb from a detection result of the detector. The wearable device is attachable to a head.

### CROSS-REFERENCE TO RELATED APPLICATION(S)

The present application is a national phase of International Application No. PCT/JP2016/071936 filed Jul. 26, 2016 and claims priority to Japanese Patent Application No. 2015-149242, filed on Jul. 29, 2015.

### FIELD

This application relates to a wearable device that is attachable to the head of a user, a control method, and a control code.

### BACKGROUND

Recently, a head-mounted display device which includes a display arranged in front of an eye and an infrared detection unit capable of recognizing a motion of a finger and is operated according to a hand gesture, is disclosed as the wearable device described above.

### SUMMARY

A wearable device attachable to a head according to one embodiment includes a detector configured to be capable of detecting an upper limb of a user existing in a real space, and a controller configured to execute a predetermined process based on detection of a rotating body motion accompanying rotation of an arm in the upper limb from a detection result of the detector.

A wearable device attachable to a user according to one embodiment includes an imager, and a controller configured to detect an upper limb of the user from a captured image captured by the imager. The controller executes a predetermined process by being triggered by detection of a rotating body motion accompanying inversion from one of a first state where the upper limb included in the captured image is a palm side and a second state where the upper limb included in the captured image is a back side of a hand to the other state.

A wearable device attachable to a head according to one embodiment includes a detector configured to be capable of detecting an upper limb of a user existing in a real space, and a controller configured to execute a predetermined process based on detection of a specific body motion accompanying both a motion in which a part of the upper limb is separated from the wearable device and a motion in which another part of the upper limb approaches the wearable device from a detection result of the detector.

In a control method executed by a wearable device according to one embodiment, the wearable device includes a detector configured to be capable of detecting an upper limb of a user existing in a real space and a controller and is attachable to a head. The controller executes a predetermined process based on detection of a rotating body motion accompanying rotation of an arm in the upper limb from a detection result of the detector.

A non-transitory computer readable recording medium recording therein a control code according to one embodiment causes a controller to execute a predetermined process in a wearable device. The wearable device includes a detector configured to be capable of detecting an upper limb of a user existing in a real space and the controller and is attachable to a head. The controller executes the predetermined process based on detection of a rotating body motion accompanying rotation of an arm in the upper limb from a detection result of the detector.

### BRIEF DESCRIPTION OF DRAWINGS

FIG. 1 is a perspective view of a wearable device 1.

FIG. 2 is a block diagram of a wearable device 1.

FIG. 3A is a perspective view schematically illustrating a detection range 51 of a detector 5 and a display region 21 of the display units 2a and 2b.

FIG. 3B is a top view of FIG. 3A.

FIG. 3C is a side view of FIG. 3A.

FIG. 4 is a view for describing a first example of a function executed by the wearable device 1.

FIG. 5 is a view for describing the first example of the function executed by the wearable device 1.

FIG. 6 is a view for describing a second example of a function executed by the wearable device 1.

FIG. 7 is a view for describing a third example of a function executed by the wearable device 1.

FIG. 8 is a view for describing a fourth example of a function executed by the wearable device 1.

FIG. 9 is a view for describing a fifth example of a function executed by the wearable device 1.

FIG. 10 is a view for describing a sixth example of a function executed by the wearable device 1.

FIG. 11 is a view for describing a first modification of the third example to the sixth example.

FIG. 12 is a view for describing a second modification of the third example to the sixth example.

FIG. 13 is a view for describing a third modification of the third example to the sixth example.

FIG. 14 is a view for describing a seventh example of a function executed by the wearable device 1.

FIG. 15 is a view for describing an eighth example of a function executed by the wearable device 1.

FIG. 16 is a view for describing a ninth example of a function executed by the wearable device 1.

FIG. 17 is a view for describing a tenth example of a function executed by the wearable device 1.

FIG. 18 is a view for describing an eleventh example of a function executed by the wearable device 1.

FIG. 19 is a view for describing a twelfth example of a function executed by the wearable device 1.

FIG. 20 is a view for describing a thirteenth example of a function executed by the wearable device 1.

### DETAILED DESCRIPTION

Embodiments for implementing a wearable device 1 according to the present application will be described in detail with reference to the drawings. In the following description, the same components will be denoted by the same reference signs in some cases. Further, a redundant description will be omitted in some cases. It should be noted that the present application is not limited by the following description. In addition, the components in the following description include those that can be easily assumed by a person skilled in the art, those that are substantially identical thereto, and those within a so-called equivalent range. In the wearable device as described above, it may be desirable to provide more favorable usability. An object of the present application may be to provide a wearable device with more favorable usability.

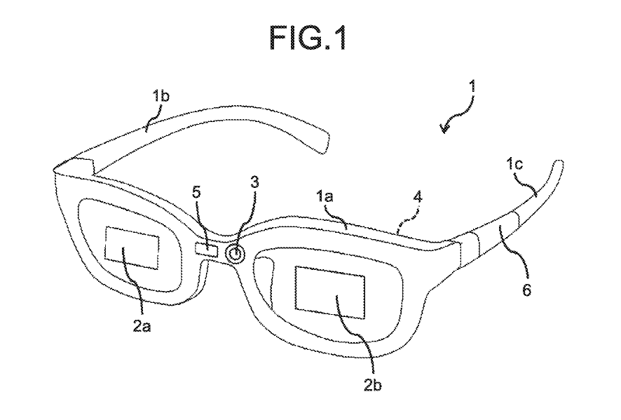

First of all, an overall configuration of the wearable device 1 will be described with reference to FIG. 1. FIG. 1 is a perspective view of the wearable device 1. As illustrated in FIG. 1, the wearable device 1 is a head-mounted type (or an eyeglass type) device which is attached to the head of a user.

The wearable device 1 has a front part 1a, a side part 1b, and a side part 1c. The front part 1a is arranged in front of the user so as to cover both the user's eyes when being attached. The side part 1b is connected to one end of the front part 1a and the side part 1c is connected to the other end of the front part 1a. The side part 1b and the side part 1c are supported by the ears of the user like the temples of eyeglasses when being attached, thereby stabilizing the wearable device 1. The side part 1b and the side part 1c may be configured in such a manner as to be connected at the back of the user's head when being attached.

The front part 1a has a display unit 2a and a display unit 2b on a face opposite to the user's eyes when being attached. The display unit 2a is arranged at a position opposite to the user's right eye when being attached, and the display unit 2b is arranged at a position opposite to the user's left eye when being attached. The display unit 2a displays an image for the right eye, and the display unit 2b displays an image for the left eye. The wearable device 1 can realize three-dimensional display using a parallax between both eyes by providing the display unit 2a and the display unit 2b that display the images corresponding to the respective eyes of the user when being attached.

The display unit 2a and the display unit 2b are a pair of transmissive or semi-transmissive displays, but embodiments are not limited thereto. For example, the display unit 2a and the display unit 2b may be provided with lenses such as eyeglass lenses, sunglass lenses, and UV cut lenses, and the display unit 2a and the display unit 2b may be provided separately from the lenses. The display unit 2a and the display unit 2b may be configured using one display device as long as both units can independently provide different images to the user's right and left eyes.

An imager 3 (out-camera) is provided in the front part 1a. The imager 3 is arranged at a center portion of the front part 1a. The imager 3 acquires an image of a predetermined range in the scenery ahead of the user. In addition, the imager 3 can also acquire an image in a range corresponding to the user's field of view. The field of view referred to here is, for example, a field of view when the user views the front. The imager 3 may be constituted by two imagers including an imager arranged in the vicinity of one end (the right eye side when being attached) of the front part 1a and an imager arranged in the vicinity of the other end (the left eye side when being attached) of the front part 1a. In this case, an image in a range corresponding to the field of view of the right eye of the user is acquired by the imager arranged in the vicinity of the one end (the right eye side when being attached) of the front part 1a, and an image in a range corresponding to the field of view of the left eye of the user is acquired by the imager arranged in the vicinity of one end (the left eye side when being attached) of the front part 1a.

An imager 4 (in-camera) is provided in the front part 1a. When the wearable device 1 is attached to the user's head, the imager 4 is arranged on a face side of the user in the front part 1a. The imager 4 acquires an image of the face of the user, for example, an image of the eyes.

A detector 5 is provided in the front part 1a. The detector 5 is arranged at a center portion of the front part 1a. In addition, an operation part 6 is provided in the side part 1c. The detector 5 and the operation part 6 will be described later.

The wearable device 1 has a function of allowing a user to visually recognize various types of information. When the display unit 2a and the display unit 2b do not perform display, the wearable device 1 allows the user to visually recognize the foreground through the display unit 2a and the display unit 2b. When the display unit 2a and the display unit 2b perform display, the wearable device 1 allows the user to visually recognize the foreground through the display unit 2a and the display unit 2b and display contents of the display unit 2a and the display unit 2b.

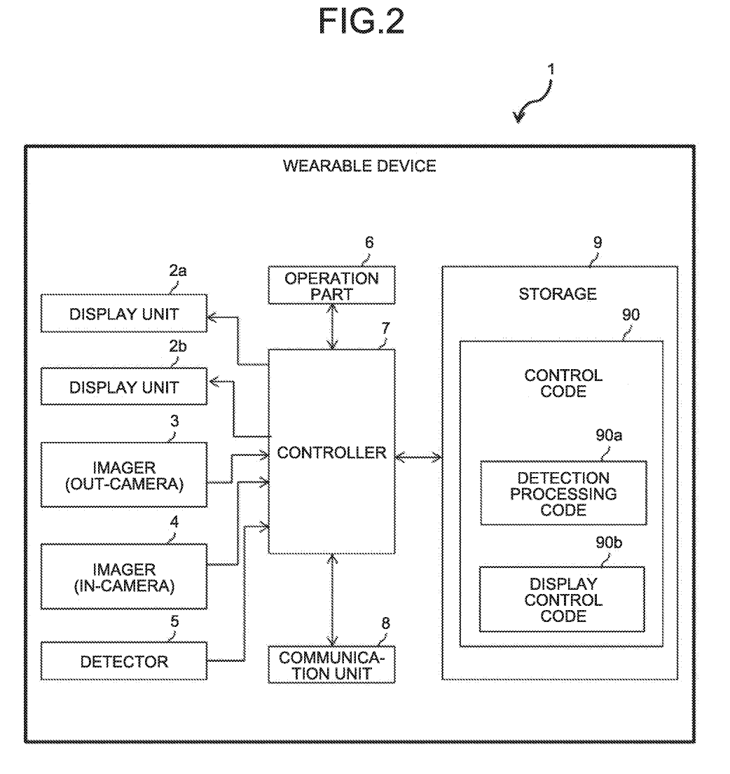

Then, a functional configuration of the wearable device 1 will be described with reference to FIG. 2. FIG. 2 is a block diagram of the wearable device 1. As illustrated in FIG. 2, the wearable device 1 includes the display units 2a and 2b, the imager 3 (out-camera), the imager 4 (in-camera), the detector 5, the operation part 6, a controller 7, a communication unit 8, and a storage 9.

The display units 2a and 2b include semi-transmissive or transmissive display devices such as a liquid crystal display and an organic electro-luminessence panel. The display units 2a and 2b display various types of information as images according to a control signal input from the controller 7. The display units 2a and 2b may be projection devices that project the images onto the user's retina using light sources such as laser beams. In this case, it may be configured such that a half mirror is installed in a lens portion of the wearable device 1 emulating glasses so that an image obtained by irradiation from a separately provided projector is projected (in the example illustrated in FIG. 1, the display units 2a and 2b represent rectangular half mirrors). As described above, the display units 2a and 2b may three-dimensionally display the various types of information. The various types of information may be displayed as if present in front of the user (a position away from the user). For example, any of a frame sequential method, a polarization method, a linear polarization method, a circular polarization method, a top-and-bottom method, a side-by-side method, an anaglyph method, a lenticular method, a parallax barrier method, a liquid crystal parallax barrier method, and a multi-parallax method such as a two-parallax method may be adopted as a method of displaying information in this manner.

The imagers 3 and 4 electronically capture images using image sensors such as a CCD (Charge Coupled Device Image Sensor) and a CMOS (Complementary Metal Oxide Semiconductor). Further, the imagers 3 and 4 convert the captured images into signals and output the signals to the controller 7.

The detector 5 detects a real object (predetermined object) existing in the foreground of the user. For example, the detector 5 detects an object that matches a preregistered object (for example, a human hand or finger) or a preregistered shape (for example, a shape of the human hand or finger) among real objects. The detector 5 has a sensor that detects a real object. The detector 5 is formed of, for example, an infrared irradiation unit that emits infrared rays and an infrared imager as a sensor capable of receiving the infrared rays reflected from a real predetermined object. As being provided in the front part 1a of the wearable device 1, the infrared irradiation unit can irradiate the front side of the user with the infrared rays. As being provided in the front part 1a of the wearable device 1, the infrared imager can detect the infrared rays reflected from the predetermined object existing in front of the user. The detector 5 may detect a real object, for example, using at least one of visible light, UV rays, radio waves, sound waves, magnetism, and electrostatic capacitance, in addition to the infrared rays.

In the present embodiment, the imager 3 (out-camera) may also serve as the detector 5. That is, the imager 3 detects an object within an imaging range by analyzing the captured image. The imager 3 is provided in the front part 1a of the wearable device 1 as illustrated in FIG. 1 in such a manner as to be capable of imaging the predetermined object in front of the user.

The operation part 6 is, for example, a touch sensor arranged in the side part 1c. The touch sensor is capable of detecting contact of the user, and receives a basic operation such as activation, stop, and change of an operation mode of the wearable device 1 according to a detection result. Although the example in which the operation part 6 is arranged in the side part 1c is illustrated in the present embodiment, embodiments are not limited thereto, and the operation part 6 may be arranged in the side part 1b or may be arranged in both of the side part 1b and the side part 1c.

The controller 7 includes a CPU (Central Processing Unit) as a computation means and a memory as a storage means and realizes various functions by executing a code using these hardware resources. Specifically, the controller 7 reads a code and data stored in the storage 9 to be loaded in the memory, and causes the CPU to execute a command included in the code loaded in the memory. Further, the controller 7 performs read and write of data with respect to the memory and the storage 9 and controls the operations of the display units 2a, 2b, and the like according to an execution result of the command using the CPU. When the CPU executes the command, the data loaded in the memory and the operation detected through the detector 5 and the like are used as some of parameters and determination conditions. The controller 7 controls the communication unit 8 to execute communication with another electronic device having a communication function.

The communication unit 8 communicates by radio. Examples of wireless communication standards supported by the communication unit 8 include a cellular phone communication standard, such as 2G, 3G, and 4G, and a short-range wireless communication standard. Examples of the cellular phone communication standard include, but are not limited to LTE (Long Term Evolution), W-CDMA (Wideband Code Division Multiple Access), WiMAX (Worldwide Interoperability for Microwave Access), CDMA 2000, PDC (Personal Digital Cellular), GSM (registered trademark) (Global System for Mobile Communications), a PHS (Personal Handy-phone System), and the like. Examples of the short-range wireless communication standard include, but are not limited to IEEE 802.11, Bluetooth (registered trademark), IrDA (Infrared Data Association), NFC (Near Field Communication), WPAN (Wireless Personal Area Network), and the like. Examples of a communication standard of the WPAN include, but are not limited to ZigBee (registered trademark). The communication unit 8 may support one or a plurality of the above-described communication standards. The wearable device 1 can transmit and receive various signals, for example, by performing wireless communication connection with another electronic device (a smartphone, a laptop computer, a television, or the like) having a wireless communication function.

The communication unit 8 may perform communication by being wiredly connected to the other electronic device such as the above-described mobile electronic device. In this case, the wearable device 1 includes a connector to which the other electronic device is connected. The connector may be a general-purpose terminal such as a USB (Universal Serial Bus), an HDMI (registered trademark) (High-Definition Multimedia Interface), a light peak (Thunderbolt (registered trademark)), and an earphone microphone connector. The connector may be a dedicated terminal such as a dock connector. The connector may be connected to various devices including, for example, an external storage, a speaker, and a communication device, other than the above-described electronic device.

The storage 9 is configured using a nonvolatile storage device such as a flash memory and stores various codes and data. The codes stored in the storage 9 include a control code 90. The storage 9 may be configured using a combination of a portable storage medium such as a memory card and a read and write device that performs read and write with respect to the storage medium. In this case, the control code 90 may be stored in the storage medium. The control code 90 may be acquired from a server device, a smartphone, a laptop computer, a television, or the like by wireless communication or wired communication.

The control code 90 provides functions relating to various types of control configured to operate the wearable device 1. The control code 90 includes a detection processing code 90a and a display control code 90b. The detection processing code 90a provides a function to detect a predetermined object existing in the foreground of the user from the detection result of the detector 5. The detection processing code 90a provides a function of detecting a position of the predetermined object in the foreground of the user and a motion of the predetermined object from the detection result of the detector 5. The display control code 90b provides a function of displaying an image so as to be visually recognized by the user and changing an image display mode according to the motion of the predetermined object.

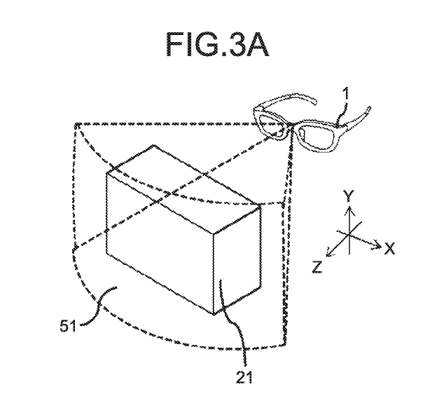

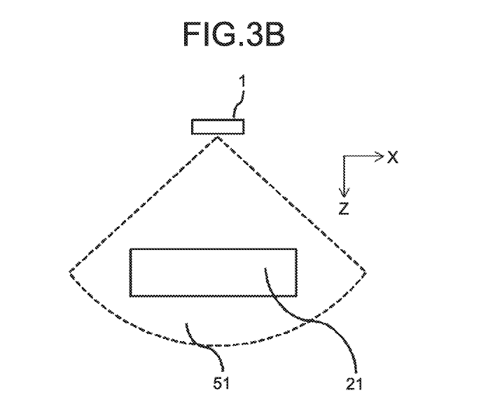

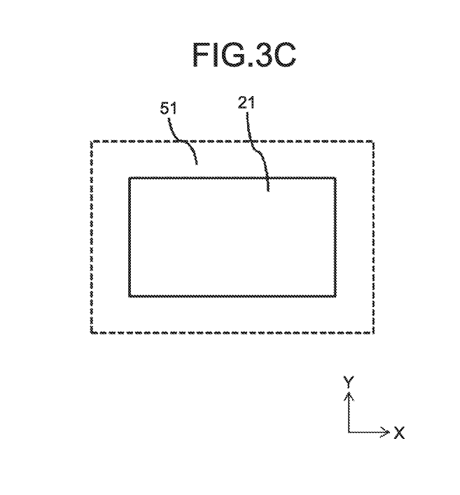

Then, a relationship between a detection range of the detector 5 and a display region of the display units 2a and 2b will be described with reference to FIGS. 3A to 3C. In the present embodiment, the description will be given assuming that the detector 5 is the sensor that detects a real predetermined object using infrared rays. The description will be given assuming that the detector 5 is formed of the infrared irradiation unit that emits infrared rays and the infrared imager capable of receiving the infrared rays reflected from the real predetermined object (having infrared sensitivity). That is, the controller 7 detects the real predetermined object using an image imaged by the infrared imager. In the present embodiment, the description will be given assuming that display images are displayed as if the display units 2a and 2b were located at positions apart from the wearable device 1.

FIG. 3A is a perspective view schematically illustrating a detection range 51 of the detector 5 and a display region 21 of the display units 2a and 2b. FIG. 3B is a top view of FIG. 3A, and FIG. 3C is a side view of FIG. 3A. In FIG. 3, a three-dimensional orthogonal coordinate system formed of an X-axis, a Y-axis, and a Z-axis is defined. An X-axis direction indicates the horizontal direction and a Y-axis direction indicates the vertical direction or a long-axis direction of the user's body. A Z-axis direction is a front- and-back direction of the user. A positive Z-axis direction indicates a direction having a greater depth in irradiation of the infrared irradiation unit included in the detector 5. FIG. 3C corresponds to the field of view when the user visually recognizes the front side.

The detection range 51 has a three-dimensional space as understood from FIGS. 3A to 3C. The detector 5 formed of the infrared irradiation unit and the infrared imager can not only detect a predetermined object in front of the user as a two-dimensional image but also detect a shape of the predetermined object. The detector 5 can not only detect the predetermined object as the two-dimensional image but also acquire depth data corresponding to position coordinate data of each pixel of the image (that is, can acquire a depth image added with the depth data). The depth data is data representing a distance between the detector 5 and the real object (predetermined object) corresponding to each pixel in the two-dimensional image.

The controller 7 can detect a body motion such as a bending motion and a stretching motion of a finger, bending of a wrist, rotation (pronation and supination) of a forearm, or rotation of a hand or a finger accompanying the rotation of the forearm as a motion of the predetermined object, for example, when the predetermined object is an arm, a hand, a finger, or combination thereof (collectively referred to as an upper limb) based on the detection result of the detector 5. The rotation (pronation and supination) of the forearm or the rotation of the hand or the finger accompanying the rotation of the forearm is referred to as a “rotating body motion”. The “rotating body motion” includes not only a motion of switching a palm side and a back side of the hand by 180-degree rotation of the forearm but also rotation of less than 180 degrees of the hand and/or finger caused by rotation of less than 180 degrees of the forearm or rotation of the hand and/or finger caused by rotation at an angle larger than 180 degrees of the forearm.

The controller 7 may detect movement of a position of a specific point of the upper limb within the detection range 51 as a body motion other than the above-described body motions. The controller 7 may detect a specific shape formed by the upper limb as a body motion. For example, a form of stretching a thumb while folding the other fingers (a sign indicating “good”) may be detected as a body motion.

When detecting the rotating body motion among the above-described body motions, the controller 7 can actually detect the rotating body motion based on a change of a shape of the upper limb detected by the detector 5 caused in the course of rotation of the forearm. The controller 7 can also detect a rotation angle of the upper limb in the rotating body motion based on the change of the shape of the upper limb detected by the detector 5 caused in the course of rotation of the forearm.

The controller 7 can actually detect the rotating body motion based on a change of depth data of the upper limb caused in the course of rotation of the forearm. The controller 7 can determine at least two regions in the upper limb in advance and detect the rotating body motion based on a relative change of the depth data between the two regions caused in the course of rotation of the forearm.

For example, when the forearm performs a rotation operation (pronation and supination) in a state where two fingers among the five fingers in the upper limb are stretched, one of the fingers moves to a position closer to the detector 5 and the other finger moves to a position farther from the detector 5 according to the rotation, and thus, it is possible to actually detect the rotating body motion by detecting the change of the depth data that is based on the movement of these positions. Further, the controller 7 can also detect the rotation angle of the upper limb in the rotating body motion based on the change of the depth data that changes according to the rotation operation of the forearm.

A method of enabling determination on whether an image of the upper limb detected by the detector 5 is the palm side or the back side of the hand based on the depth data and detecting a rotating body motion based on a change from one of a state of the palm side and a state of the back side of the hand to the other state caused by the body motion may be adopted as a method of detecting the rotating body motion other than the above-described method. The controller 7 can determine that the detected upper limb is the palm side if a central portion of a hand region included in an image acquired by the infrared imager has a concave shape in a depth direction, and can determine that the detected upper limb is the back side of the hand if the central portion has a convex shape in the depth direction.

Even when the imager 3 (out-camera) is applied as the detector, the controller 7 can detect the predetermined object within the detection range (within the imaging range) and detect the motion and the like of the predetermined object, which is similar to the detector 5.

When detecting the rotating body motion among the above-described body motions, the controller 7 can actually detect the rotating body motion based on a change of the shape of the upper limb in the captured image of the imager 3 caused in the course of rotation of the forearm. The controller 7 can also detect the rotation angle of the upper limb in the rotating body motion based on a change in the shape of the upper limb in the captured image caused in the course of rotation of the forearm.

The controller 7 may analyze a captured image, be capable of determining either the palm side or the back side of the hand depending on whether nails of the hand are detected in a region recognized as the hand in the captured image (that is, determining as the palm side unless the nails are detected and determining as the back side of the hand if the nails are detected), and detect that the rotating body motion has been performed based on a change from one of the palm side and the back side of the hand to the other caused by the body motion. The controller 7 can also detect the rotation angle of the upper limb in the rotating body motion based on a change of shapes of the nails of the hand or a change of sizes of regions regarded as the nails in the captured image caused in the course of rotation of the forearm.

A method of enabling determination on either the palm side or the back side of the hand based on whether there is a palm print (hand wrinkles) in a region recognized as the hand in the captured image and detecting a rotating body motion based on a change from one of the palm side and the back side of the hand to the other caused by the body motion may be adopted as the method of detecting the rotating body motion other than the above-described method.

Various well-known methods other than the above-described methods may be adopted as the method of detecting the rotating body motion and the rotation angle of the upper limb caused by rotating body motion.

Then, the display units 2a and 2b display images so as to be visually recognizable by the user in the display region 21, which is not an actually provided portion in the wearable device 1 but is located at a position away from the wearable device 1 (hereinafter, the images displayed by the display units 2a and 2b will be referred to as display images in some cases) as understood from FIGS. 3A to 3C. At this time, the display units 2a and 2b may display the display image as a 3D object in a three-dimensional shape having a depth. The depth corresponds to a thickness in the Z-axis direction. However, the display units 2a and 2b may display the images in actually provided portions of the display units 2a and 2b of the wearable device 1 instead of displaying the images so as to be visually recognizable in the display region 21 away from the wearable device 1.

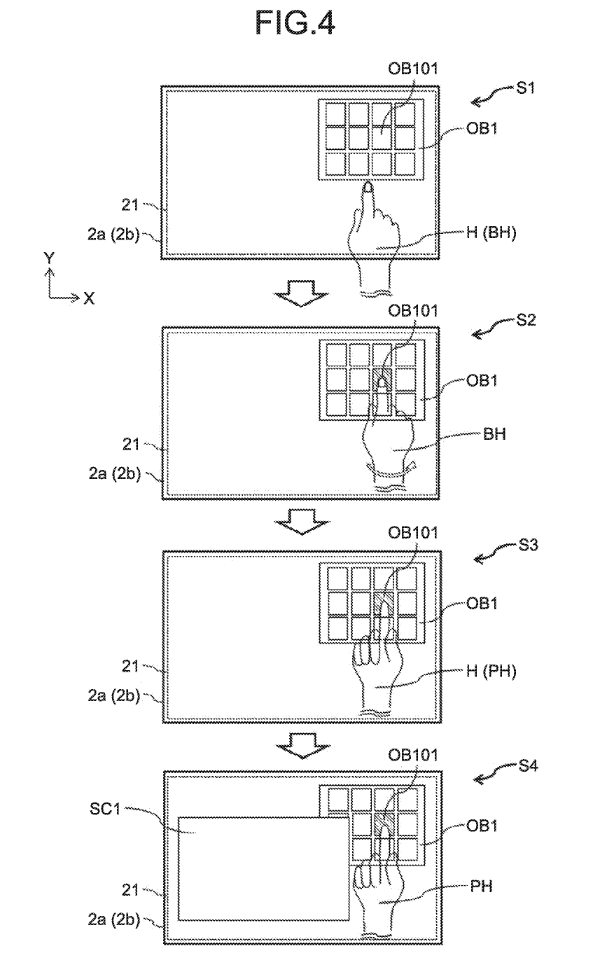

Then, an overview of a function executed by the wearable device 1 according to the present embodiment will be described with reference to FIGS. 4 to 20. Various functions to be described below are provided by the control code 90. FIG. 4 is a view for describing a first example of the function executed by the wearable device 1.

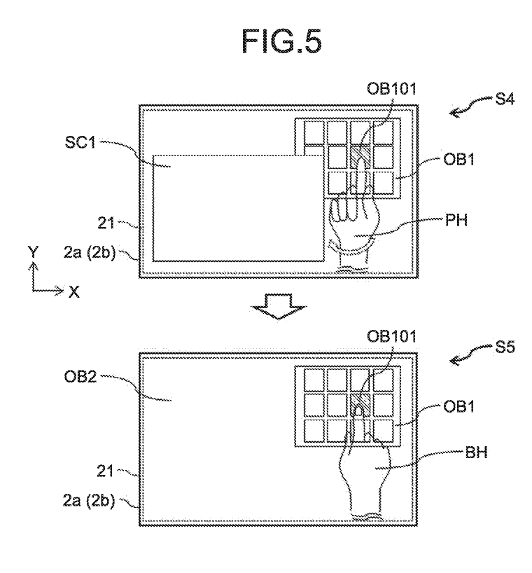

FIG. 4 illustrates the display unit 2a or 2b (hereinafter simply referred to as the display unit 2 in some cases) of the wearable device 1, the display region 21, and the user's upper limb. FIG. 4 does not illustrate the other components in the wearable device 1. FIG. 4 is illustrated substantially as a region that can be visually recognized by the user in a two-dimensional manner. The same description also applies to examples of FIGS. 5 to 20 to be described later.

In Step S1, the user visually recognizes a back side BH (hereinafter simply referred to as a hand BH in some cases) of a right hand H as the upper limb of the user through the display region 21. It is assumed that the hand BH exists within the detection range 51 of the detector 5, and thus, the wearable device 1 recognizes the existence of the hand BH based on the detection result of the detector 5. The same description also applies to examples of FIGS. 5 to 20 to be described later. The wearable device 1 displays an icon group OB1 formed of a plurality of icons indicating that it is possible to execute a predetermined function, associated with each icon in advance, on the display unit 2 by the user's operation (an instruction operation such as selection and execution). The icon group OB1 is displayed as a transparent or translucent image in the first example, and thus, the state where the user can visually recognize the upper limb through the icon group OB1 is formed. However, embodiments are not limited thereto, and the icon group OB1 may be displayed as an opaque image.

When the user moves the hand BH such that a fingertip of an index finger of the hand BH is superimposed on a display range of one icon OB101 in the icon group OB1 in Step S1, the wearable device 1 regards the icon OB101 as being selected by the user and changes a display mode of the icon OB101 (Step S2). The wearable device 1 estimates a range of a real space that is recognized by the user in the state of being superimposed on the display region 21 in advance, and thus, it is possible to estimate which position of the display region 21 is superimposed and visually recognized according to a detected position of the index finger within the range. The icon or the icon group is defined as one of display images in the present embodiment.

Further, when the hand BH is inverted (Step S3) as the user rotates the forearm (rotation in a direction indicated by the dotted-line arrow in FIG. 4, that is, supination) in a state illustrated in Step S2, that is, in a state where the icon OB101 is selected, the wearable device 1 detects that a rotating body motion has been performed. Further, the wearable device 1 regards an execution operation of the function associated with the icon OB101 as being performed by the user based on the detection of the rotating body motion, and starts to execute the function (Step S4). In Step S4, the wearable device 1 displays an execution screen SC1 of the function in the display region 21 of the display unit 2 along with the execution of the function associated with the icon OB101. The palm side of the right hand H is referred to as a hand PH as illustrated in Steps S3 and S4.

As described above, the wearable device 1 according to the present embodiment includes the detector 5 that is capable of detecting the user's upper limb existing in the real space, and the controller 7 that executes a predetermined process (activation of the function associated with the icon OB101 in the first example) based on the detection of the rotating body motion accompanying the rotation of the arm in the upper limb from the detection result of the detector 5.

The wearable device 1 according to the present embodiment further includes the display unit 2 that displays the display image in front of the user's eyes, and the controller 7 is configured to execute a first process (in the first example, the execution of the function associated with the icon OB101 or the display of the execution screen SC1) relating to the display image as the predetermined process. The “first process” to be described hereinafter is a process mainly relating to predetermined display control.

For example, in a configuration in which a predetermined function is executed based on movement of the upper limb to a predetermined position as a motion of the user's upper limb existing in the real space, the function is executed even when the user unintentionally moves the upper limb, and as a result, an erroneous operation occurs. On the other hand, the wearable device 1 according to the present embodiment is configured to execute a predetermined function based on the body motion accompanying the rotating option of the forearm that is less likely to unintentionally move instead of having the configuration in which the predetermined function is executed based on the movement of the upper limb, and thus, can make the erroneous operation hardly occur.

In the above example, the detector 5 has the configuration of including the infrared irradiation unit and the infrared imager, but the imager 3 may also serve as the detector as described above.

The wearable device 1 according to the present embodiment may be a wearable device that is attachable to the user including an imager (may be the imager 3 or the infrared imager in the detector 5 described above) and the controller 7 that detects the user's upper limb from a captured image captured by the imager, and may be characterized in that the controller 7 executes a predetermined process triggered by detection of a rotating body motion accompanying inversion from one of a first state where the upper limb included in the captured image is the palm side and a second state where the upper limb included in the captured image is the back side of the hand to the other state.

In the first example, the example in which the wearable device 1 is configured to detect the rotating body motion based on the inversion from the back side of the hand to the palm side, that is, the detection of the body motion accompanying the 180-degree rotation of the forearm has been illustrated. However, embodiments are not limited thereto, and it may be configured such that the rotating body motion is detected based on detection of rotation of the upper limb that is equal to or larger than a predetermined angle accompanying the rotation of the forearm.

The case where the position of the fingertip of the index finger of the right hand H does not substantially change before and after performing the rotating body motion has been exemplified in the first example. In such a case, the user performs the rotating body motion with the stretched index finger as a rotation axis. However, the mode of the rotating body motion is not limited thereto. It may be configured such that even a body motion in which the rotational axis does not coincide with the index finger and a position of the fingertip of the index finger is different before and after performing the rotating body motion is detected as the rotating body motion. That is, it may be configured such that the controller 7 executes the first process relating to a display image selected based on a position of the upper limb at the time that is before the detection of the rotating body motion (object OB101 (Step S2) in the first example) when detecting the rotating body motion in the wearable device 1. In contrast, it may be configured such that the wearable device 1 does not execute the predetermined process with a rotating body motion of the case where the position of the fingertip of the index finger (predetermined region on the upper limb) is different before and after performing the rotating body motion, but execute the predetermined process based on detection of a rotating body motion of the case where the position of the fingertip of the index finger (predetermined region on the upper limb) substantially coincides before and after performing the rotating body motion.

FIG. 5 is a view for describing the first example of the function executed by the wearable device 1 subsequently to FIG. 4. Step S4 illustrated in FIG. 5 is the same state as Step S4 illustrated in FIG. 4, that is, the state where the function that is based on the icon OB101 is executed. In a state illustrated in Step S4, when the hand PH is inverted as the user rotates the forearm in a direction opposite to the direction in Step S2 of FIG. 4 (rotation in a direction indicated by the dotted-line arrow in FIG. 5, that is, pronation), the wearable device 1 regards an operation of ending execution of the function associated with the icon OB101 as being performed by the user and ends the execution of the function (Step S5). In Step S5, the wearable device 1 does not display the execution screen SC1 along with the end of the execution of the function.

As described above, the controller 7 has the configuration of executing the predetermined process based on detection of a body motion (the supination motion in the first example) accompanying one of the pronation motion and supination motion of the arm as the rotating body motion, and ends the first process based on detection of a body motion accompanying the other motion of the pronation motion and the supination motion (the pronation motion in the first example) during the execution of the first process, in the wearable device 1 according to the present embodiment. The execution of the predetermined process in the first example may be execution of the function associated with the icon OB101 or may be display of the function execution screen SC1 as the first process accompanying the execution of the function. The end of the first process in the first example may be to end the execution of the function associated with the icon OB101, or the non-display of the function execution screen SC1 as the first process.

The wearable device 1 according to the present embodiment may be configured such that the controller 7 executes the predetermined process based on the detection of the body motion accompanying one of the pronation motion and supination motion of the arm as the rotating body motion, and executes a second process containing control contents forming a pair with the first process based on detection of a body motion accompanying the other motion of the pronation motion and the supination motion within a predetermined time after execution of the first process, which is different from the above-described configuration. For example, it may be configured such that, when an electronic file that has been selected before a body motion is deleted based on detection of the body motion accompanying one of the pronation motion and the supination motion of the arm, the electronic file that has been deleted is returned (or restored) to its original position if the other motion of the pronation motion and the supination motion of the arm is detected within a predetermined time after the deletion.

The wearable device 1 may be configured such that a predetermined process is executed while storing which one between the pronation motion and supination motion of the arm that is accompanied by a rotating body motion when detecting the rotating body motion, and whether a rotating body motion reverse to the stored rotating body motion is detected is monitored during execution of the predetermined process or within a predetermined time after the execution thereof.

Although the configuration in which the function is executed based on the transition from the back side BH of the hand to the palm side PH and the function is stopped based on the transition from the palm side PH to the back side BH of the hand has been exemplified in the first example, embodiments are not limited thereto, and the reversed configuration may be employed. That is, the function may be executed based on the transition from the palm side PH to the back side BH of the hand, and the function may be stopped based on the transition from the back side BH of the hand to the palm side PH. The wearable device 1 according to the present embodiment may be characterized by executing the same predetermined process based on either a body motion accompanying a rotating motion in a first direction (for example, the supination motion) of the forearm or a body motion accompanying a rotating motion in a second direction opposite to the first direction (for example, the pronation motion) of the forearm.

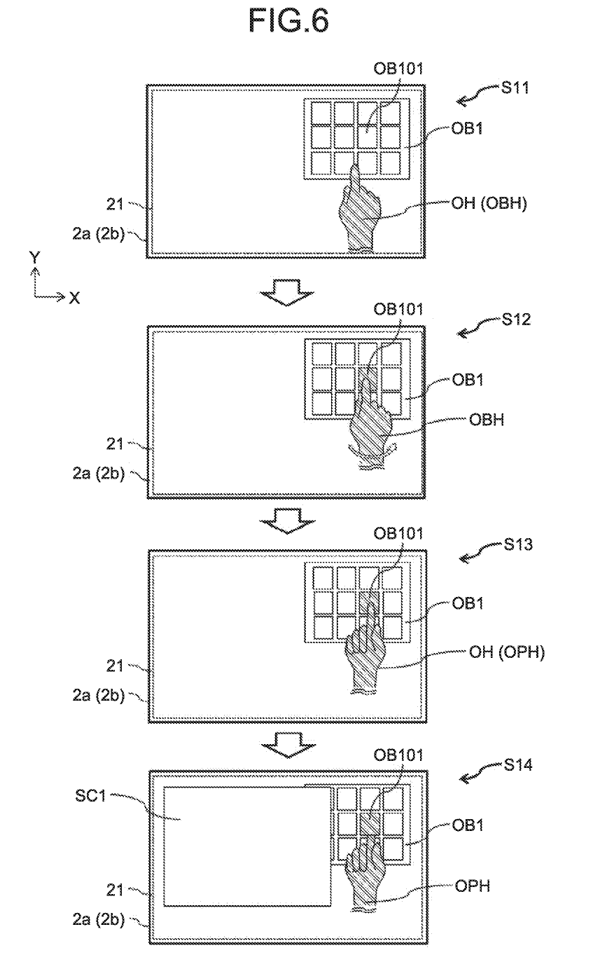

FIG. 6 is a view for describing a second example of the function executed by the wearable device 1. In the second example, the wearable device 1 displays a hand object OH emulating the user's upper limb in the display region 21 of the display unit 2. The hand object OH is displayed at a display position that is based on the position of the user's upper limb in the real predetermined space detected by the detector 5 as an image having substantially the same shape as a shape of the user's upper limb detected by the detector 5. According to this configuration, the wearable device 1 can appropriately set a detection range for specifying a position of the display region 21 within the detection range 51 of the detector 5, and thus, it is possible to perform an operation that is based on the body motion of the upper limb, for example, without raising the upper limb to a height of a line of vision of the user.

In Step S11, it is assumed that the user causes the back side of the hand to face the detector 5 in the real space. The detector 5 displays a hand object OBH representing the back side of the hand of the upper limb on the display unit 2 based on detection of the back side of the hand of the upper limb of the user.

In Step S11, the wearable device 1 displays the icon group OB1 formed of a plurality of icons. When the user moves the upper limb in the real space so that the hand object OBH is moved and a fingertip of the hand object OBH is superimposed on the display range of the icon OB101, the wearable device 1 regards the icon OB101 as being selected by the user and changes the display mode of the icon OB101 (Step S12).

Further, when the user rotates the forearm (rotation in a direction indicated by the dotted-line arrow in FIG. 6, that is, supination) in a state where the icon OB101 is selected, the wearable device 1 detects that the rotating body motion has been performed and inverts the display mode of the hand object OBH, which is the state of the back side of the hand, to the state of the palm side (Step S13). Further, the wearable device 1 regards the operation of executing the function associated with the icon OB101 as being performed by the user based on the detection of the rotating body motion, and starts to execute the function (Step S14). In Step S14, the wearable device 1 displays the execution screen SC1 of the function in the display region 21 of the display unit 2 along with the execution of the function associated with the icon OB101. The hand object OH in the state of the palm side is denoted as the hand object OPH as illustrated in Steps S13 and S14.

In the configuration in which the hand object OH that is based on the position and the shape of the upper limb in the real space is displayed on the display unit 2 as in the second example, a front-and-back relationship between the icon OB101 and the hand object OH superimposed on each other may be changed before the rotating body motion is performed and after the rotating body motion has been performed. As illustrated in FIG. 6, a display mode in which the hand object OH is displayed on the front side of the icon OB101, that is, the hand object OH is displayed with priority over the object OB101 may be made before the rotating body motion is performed. On the other hand, the display mode may be changed to a display mode in which the hand object OH is displayed on the back side of the object OB101, that is, the icon OB101 is displayed with priority over the hand object OH after the rotating body motion has been performed. In this manner, it becomes easy for the user to visually recognize the detection of the rotating body motion, and thus, the usability of the wearable device 1 is improved. A display mode in which two images are partially superimposed on each other and a part of one of the display images is displayed with priority over a part of the other image is referred to as that “a plurality of display images is displayed to have the front-to-back relationship with each other”.

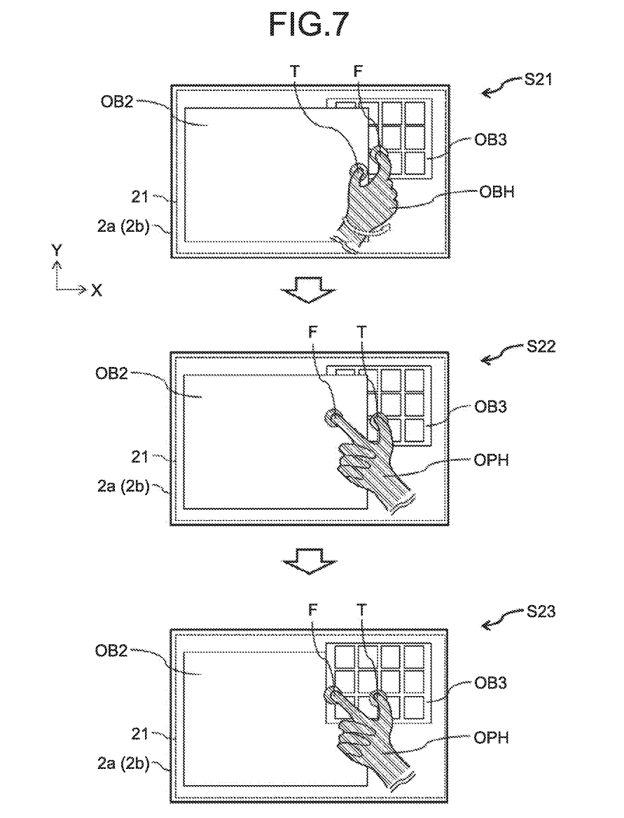

FIG. 7 is a view for describing a third example of the function executed by the wearable device 1. In the third example, the wearable device 1 displays the hand object OH having substantially the same shape as the shape of the upper limb in the real space on the display unit 2 at the display position based on the position of the upper limb in the real space.

The wearable device 1 displays an object OB2 and an object OB3 in the display region 21 of the display unit 2. The object OB2 and the object OB3 are displayed to be partially superimposed on each other. The object OB2 is displayed on the front side of the object OB3, that is, the object OB2 is display with priority over the object OB3. That is, the plurality of display images (the objects OB2 and OB3) is displayed to have a front-and-back relationship with each other. In the present specification, a description will be given assuming that anything that is referred to as an “object (excluding the hand object)” corresponds to a display image.

In Step S21, the user causes the back side of the hand to face the detector 5 in the real space. The wearable device 1 displays the hand object OBH representing the back side of the hand of the upper limb in the display region 21 based on the detection of the back side of the hand of the upper limb of the user from the detection result of the detector 5. As the user separates the index finger and the thumb from each other, a fingertip F of the index finger and a fingertip T of the thumb in the hand object OBH are displayed to be separated from each other. In the hand object OBH, the fingertip F of the index finger is superimposed on the object OB3, and the fingertip T of the thumb is superimposed on the object OB2. At this time, the wearable device 1 regards both the object OB2 and the object OB3 as being selected by the user. The wearable device 1 displays a circular display effect around each of the fingertip F of the index finger and the fingertip T of the thumb in the hand object OBH in order to make it easy to visually recognize that each of the object OB2 and the object OB3 is selected as illustrated in FIG. 7.

In Step S21, when the user rotates the forearm (rotation in a direction indicated by the dotted-line arrow in FIG. 7, that is, supination) (Step S22), the wearable device 1 detects that the rotating body motion has been performed and changes a front-and-back relationship between the object OB2 and the object OB3 (Step S23). As illustrated in Step S23, a display mode may be changed to the display mode in which the object OB3 is displayed on the front side of the object OB2, that is, the object OB3 is displayed with priority over the object OB2 based on the change in the front-and-back relationship caused by the rotating body motion. The wearable device 1 displays the hand object OPH representing the palm side of the upper limb in the display region 21 after detecting the rotating body motion.

As described above, the wearable device 1 according to the present embodiment has the configuration in which the display unit 2 displays a plurality of display images, and the controller 7 executes the first process when detecting the rotating body motion in a state where the plurality of display images is specified.

In this configuration, the controller 7 can consider that the plurality of display images has been specified based on a fact that the hand object OH displayed based on the position of the upper limb is superimposed on the display images as the upper limb exists at a predetermined position in the real space. Even when it is estimated that the position of the upper limb in the real space is visually recognized by the user as if superimposed on the display image, it may be regarded that the display image has been specified by the upper limb.

Further, the controller 7 may be configured to be capable of executing the first process when detecting the rotating body motion in a state where a first display image among the plurality of display images is specified by a part of the upper limb (the fingertip of the index finger) and a second display image among the plurality of display images is specified by the other part of the upper limb (the fingertip of the thumb).

Further, the controller 7 has the configuration of changing the front-and-back relationships among the plurality of display images as the first process. Although the configuration in which the object OB2 is specified based on the superimposition of the fingertip T of the thumb on the object OB2 in the object OBH and the object OB3 is specified based on the superimposition of the fingertip F of the index finger on the object OB3 has been exemplified in the third example, embodiments are not limited to this configuration.

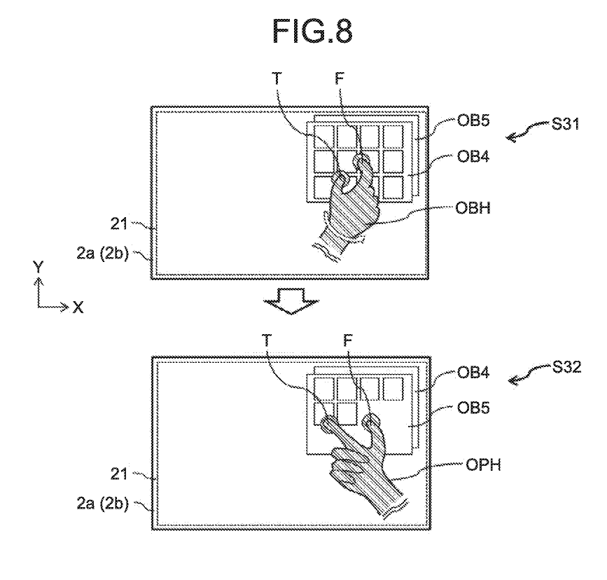

FIG. 8 is a view for describing a fourth example of the function executed by the wearable device 1. In the fourth example, the wearable device 1 displays the hand object OH having substantially the same shape as the shape of the upper limb in the real space on the display unit 2 at the display position based on the position of the upper limb in the real space.

The wearable device 1 displays an object OB4 and an object OB5 in the display region 21 of the display unit 2. The object OB4 and the object OB5 are displayed such that the most parts thereof are superimposed on each other. The object OB4 is displayed on the front side of the object OB5, that is, the object OB4 is displayed with priority over the object OB5.

In Step S31, the user causes the back side of the hand to face the detector 5 in the real space. The detector 5 of the wearable device 1 displays a hand object OBH representing the back side of the hand of the upper limb on the display unit 2 based on detection of the back side of the hand of the upper limb of the user. The user moves the hand object OBH to a position to be superimposed on the object OB4 by moving the upper limb to a predetermined position in the real space. At this time, the wearable device 1 recognizes that a part of the hand object OBH is superimposed on the object OB4 from a detection result of the detector 5.

In Step S31, when the user rotates the forearm (rotation in a direction indicated by the dotted-line arrow in FIG. 8, that is, supination) (Step S31), the wearable device 1 detects that the rotating body motion has been performed and changes a front-and-back relationship between the object OB4 and the object OB5. (Step S32). As illustrated in Step S32, a display mode may be changed to the display mode in which the object OB5 is displayed on the front side of the object OB4, that is, the object OB5 is displayed with priority over the object OB4 based on the change in the front-and-back relationship caused by the rotating body motion.

According to the configuration exemplified in the fourth example, it is possible to change front-and-back relationships among a plurality of display images having the front-and-back relationships with each other based on the rotating body motion without the configuration as in the third example in which the object OB2 is specified by causing the fingertip T of the thumb which is a part of the upper limb to be superimposed on the object OB2 and the object OB3 is specified by causing the fingertip F of the index finger as the other part of the upper limb to be superimposed on the object OB3.

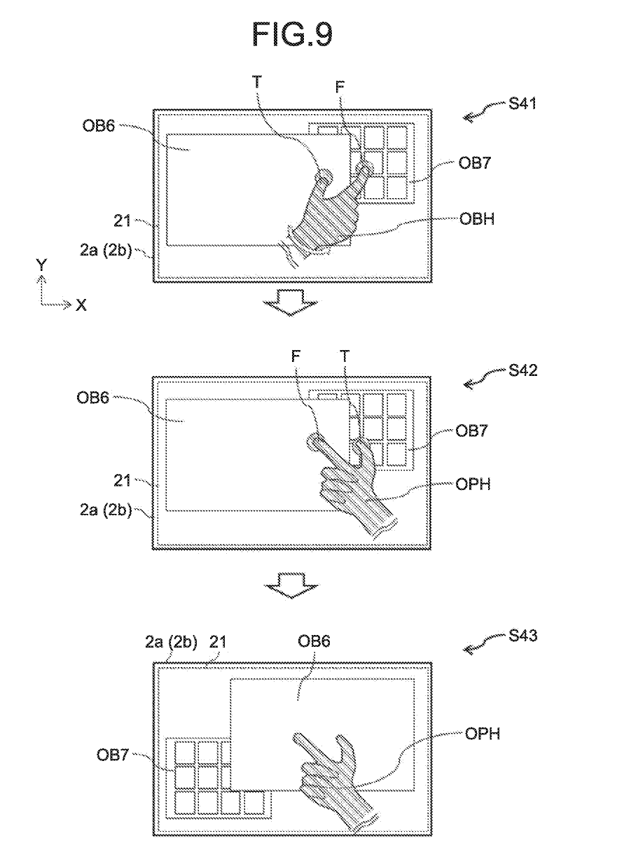

FIG. 9 is a view for describing a fifth example of the function executed by the wearable device 1. In the fifth example, the wearable device 1 displays the hand object OH having substantially the same shape as the shape of the upper limb in the real space on the display unit 2 at the display position based on the position of the upper limb in the real space.

The wearable device 1 displays an object OB6 and an object OB7 in the display region 21 of the display unit 2. The object OB6 and the object OB7 are displayed to be partially superimposed on each other. The object OB6 is displayed on the front side of the object OB7, that is, the object OB6 is displayed with priority over the object OB7.

In Step S41, the user causes the back side of the hand to face the detector 5 in the real space. The detector 5 displays a hand object OBH representing the back side of the hand of the upper limb on the display unit 2 based on detection of the back side of the hand of the upper limb of the user. As the user separates the index finger and the thumb from each other, the fingertip of the index finger and the fingertip of the thumb in the hand object OBH are displayed to be separated from each other. In the hand object OBH, the fingertip of the index finger is superimposed on the object OB7, and the fingertip of the thumb is superimposed on the object OB6. At this time, the wearable device 1 regards both the object OB6 and the object OB7 as being selected by the user. The wearable device 1 displays a display effect around each of the fingertip of the index finger and the fingertip of the thumb in the object OBH in order to make it easy to visually recognize that each of the object OB6 and the object OB7 is selected as illustrated in FIG. 9.

In Step S41, when the user rotates the forearm (rotation in a direction indicated by the dotted-line arrow in FIG. 9, that is, supination) (Step S42), the wearable device 1 detects that the rotating body motion has been performed and switches specified display positions of the object OB6 and the object OB7 (Step S43).

At this time, when switching the display positions of the object OB6 and the object OB7, the wearable device 1 changes the display position such that a corner of the object OB6 on the closest side to the object OB7 (an upper right corner in Step S42) is at a position coinciding with an upper right corner of the object OB7 that is before performing the rotating body motion (Step S42). The wearable device 1 changes the display position such that a corner of the object OB7 on the closest side to the object OB6 (a lower left corner in Step S42) is at a position coinciding with a lower left corner of the object OB6 that is before performing the rotating body motion (Step S42).

However, the mode of switching the display positions of the object OB6 and the object OB7 is not limited thereto. For example, the wearable device 1 may switch the display positions of the respective objects such that a specific point of the object OB6 (for example, a center position of the object OB6) and a point corresponding to the specific point of the object OB6 of the object OB7 (a center position of the object OB7) are switched. The wearable device 1 may detect an alignment direction of a part and the other part of the upper limb that specify the two display images, respectively, or a rotation direction in the rotating body motion (both the directions are assumed to be the X-axis direction in the fifth example) and switch a relative relationship of display positions of the two display images in the detected direction (X-axis direction) when detecting the rotating body motion. In this case, a relative relationship of the display positions of the two display images in the Y-axis direction may be arbitrary when changing the display positions of the two display images. When the alignment direction of a part and the other part of the upper limb that specify the two display images, respectively, or the rotational direction in the rotating body motion is the Y-axis direction, the relative relationship of the display positions of the two display images in the Y-axis direction may be switched, which is different from the above example. The wearable device 1 may be configured to move the display position of the object OB6, superimposed on the fingertip of the thumb of the hand object OH, to a position to be at least superimposed on the fingertip of the thumb that is after performing the rotating body motion, and further, to move the display position of the object OB7, superimposed on the fingertip of the index finger of the hand object OH, to a position to be at least superimposed on the fingertip of the index finger that is after performing the rotating body motion.

As described above, the controller 7 has the configuration of switching the display positions of the plurality of display images as the first process based on the detection of the rotating body motion in the wearable device 1 according to the present embodiment. In the above example, positions of fingertips of two fingers are switched by a rotating body motion when the rotating body motion is performed after specifying the two display images with the two fingers, respectively, and thus, the operation of switching the display positions of the plurality of display images according to such a mode can allow the user to obtain a superior operation feeling.

Although the configuration in which the display positions of the plurality of display images are simply switched before and after the rotating body motion, as display control, when detecting the rotating body motion in the state where the plurality of display images is specified has been exemplified in the fifth example, embodiments are not limited to this configuration.

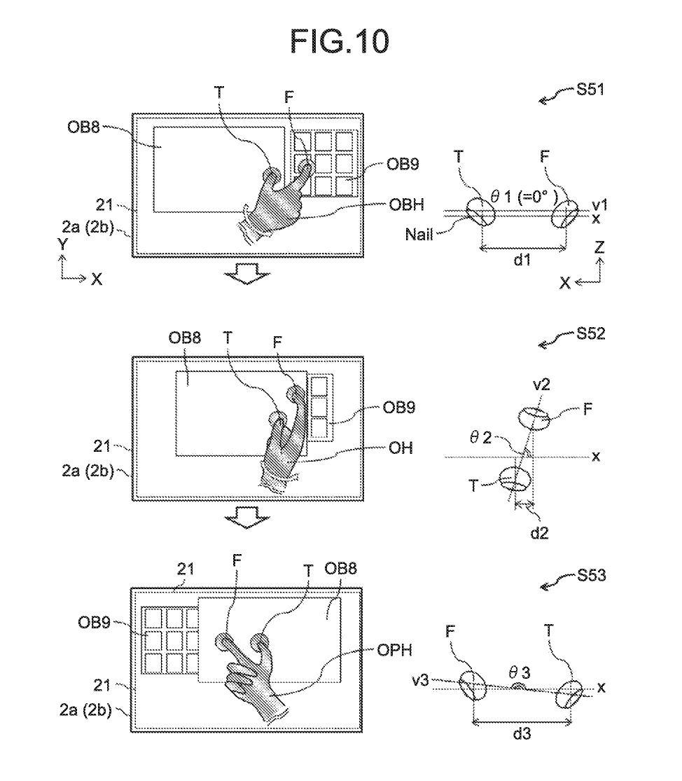

FIG. 10 is a view for describing a sixth example of the function executed by the wearable device 1. A region (corresponding to an X-Y plane in FIG. 3) that can be visually recognized by the user in a two-dimensional manner is illustrated on the left side in FIG. 10, and a region (corresponding to an X-Z plane in FIG. 3) that can be visually recognized when viewed in a vertical direction from an upper side of the user's head is illustrated on the right side.

In the sixth example, the wearable device 1 displays the hand object OH having substantially the same shape as the shape of the upper limb in the real space on the display unit 2 at the display position based on the position of the upper limb in the real space. The wearable device 1 displays an object OB8 and an object OB9 in the display region 21.

In Step S51, the user causes the back side of the hand to face the detector 5 in the real space. The detector 5 displays a hand object OBH representing the back side of the hand of the upper limb in the display region 21 based on detecting the back side of the user's upper limb (left side of Step S51). As the user separates the index finger and the thumb from each other, the fingertip F of the index finger and the fingertip T of the thumb in the hand object OBH are displayed to be separated from each other. In the hand object OBH, the fingertip F of the index finger is superimposed on the object OB9, and the fingertip region T of the thumb is superimposed on the object OB8. At this time, the wearable device 1 regards both the object OB8 and the object OB9 as being selected by the user.

As illustrated on the right side of Step S51, the fingertip F of the index finger and the fingertip T of the thumb on the user's upper limb are in the state of being located at positions to have substantially the same distance in the Z-axis direction. That is, the state illustrated in Step S51 is a state where the user visually recognizes that both the fingertip F of the index finger and the fingertip T of the thumb are located at positions separated from the user by substantially the same distance. In Step S51, the fingertip F of the index finger and the fingertip T of the thumb are separated from each other by a distance d1 indicated by the double-headed arrow in the X-axis direction.

In Step S51, the wearable device 1 detects that the rotating body motion has been performed and detects an X-axis direction component d2 of the distance between the fingertip F of the index finger and the fingertip T of the thumb. In Step S52, the distance d2 is smaller than the distance d1 in Step S51. The wearable device 1 detects an angle corresponding to the amount of a change of the distance d as a rotation angle in the rotating body motion based on a fact that the distance d between the fingertip F of the index finger and the fingertip T of the thumb has changed due to the rotating body motion.

The wearable device 1 decreases the distance between the object OB8 and the object OB9 in the X-axis direction (Step S52) based on the decrease of the distance between the fingertip F of the index finger and the fingertip T of the thumb from the distance d1 to the distance d2, which is triggered by detection of the rotating body motion in Step S51.

Subsequently, when the user further rotates the forearm (rotation in a direction indicated by the dotted-line arrow in FIG. 10, that is, supination) in Step S52, the wearable device 1 detects the change amount of the distance d between the fingertip F of the index finger and the fingertip T of the thumb again. The wearable device 1 detects that the distance d between the fingertip F of the index finger and the fingertip T of the thumb has changed to a distance d3 via a state of being zero based on the rotating body motion, thereby detecting that the relative positions in the X-axis direction between the fingertip F of the index finger and the fingertip T of the thumb have been switched. In other words, the wearable device 1 detects that the fingertip F of the index finger is positioned on the left side of the fingertip T of the thumb in Step S53 while detecting that the fingertip F of the index finger is positioned on the right side of the fingertip T of the thumb in Step S52. The wearable device 1 changes the relative positions in the X-axis direction between the object OB8 and the object OB9 as illustrated in Step S53 based on the fact that the relative positions in the X-axis direction between the fingertip F of the index finger and the fingertip T of the thumb is switched. In Step S52, the wearable device 1 changes display positions of the respective objects such that the object OB9 is located on the left side of the object OB8 and display the object OB9 and the object OB8 to be separated from each other by a distance corresponding to the distance d3 between the fingertip F of the index finger and the fingertip T of the thumb in Step S53 while displaying the respective objects such that the object OB9 is positioned on the right side of the object OB8 in Step S52.

As described above, the controller 7 has the configuration of changing relative positions between the first display image and the second display image according to a change of a component (the distance d) in a predetermined direction of the distance between a part of the upper limb (the fingertip of the index finger) and the other part (the fingertip of the thumb) accompanying the rotating body motion when detecting the rotating body motion in the wearable device 1 according to the present embodiment. The wearable device 1 may change the relative positions between the first display image and the second display image according to the rotation angle of the rotating body motion instead of the change of the component (the distance d) in the predetermined direction of the distance between a part and the other part of the upper limb accompanying the rotating body motion.

Referring again to FIG. 10, when the user rotates the forearm (rotation in a direction indicated by the dotted-line arrow in FIG. 10, that is, supination) in Step S51, the wearable device 1 detects that the rotating body motion has been performed and detects the rotation angle of the upper limb in the rotating body motion. The rotation angle may be set as the amount of a change of an angle θ, formed between a virtual line v between an arbitrary point (for example, the center) of the fingertip F of the index finger and an arbitrary point (for example, the center) of the fingertip T of the thumb and a reference line x parallel to the X-axis, for example, as illustrated on the right side of FIG. 10. Since both the fingertip F of the index finger and the fingertip T of the thumb are located at the positions separated from the user by substantially the same distance, that is, a virtual line v1 is parallel to the reference line x in the state illustrated in Step S51, an angle θ1 is zero. On the other hand, a virtual line v2 is not parallel to the reference line x in Step S52 since the rotating body motion has been performed so that the angle θ changes from the angle θ1 to an angle θ2. The rotation angle may be defined as an angle at which a line segment is tilted with an arbitrary point, for example, a center point of the line segment between the fingertip F of the index finger and the fingertip T of the thumb as a rotation center. The above-described various methods and other known methods may be appropriately adopted as the method of detecting the rotation angle.

The wearable device 1 regards the fingertip F of the index finger and the fingertip T of the thumb as being close to each other in the X-axis direction based on a fact that the angle θ formed between the virtual line v and the reference line x has changed from the angle θ1 to θ2 (0°≤θ1<θ2≤90°) by the rotating body motion, and changes the display positions such that the distance in the X-axis direction between the object OB8 and the object OB9 is reduced with such regard as a trigger (Step S52). When displaying the object OB8 and the object OB9 by reducing the distance therebetween in the X-axis direction, the wearable device 1 displays the object OB8 and the object OB9 to be partially superimposed on each other.

Subsequently, when the user further rotates the forearm (rotation in a direction indicated by the dotted-line arrow in FIG. 10, that is, supination) in Step S52, the wearable device 1 detects the rotation angle of the upper limb, that is, the change amount of the angle θ again. The wearable device 1 detects that the relative positions in the X-axis direction between the fingertip F of the index finger and the fingertip T of the thumb have been switched based on a change of the angle θ formed between the virtual line v and the reference line x from the angle θ2 (0°≤θ2≤90°) to an angle θ3 (90°≤θ3≤180°) due to transition from Step S52 to Step S53 by the rotating body motion. The wearable device 1 changes the relative display positions in the X-axis direction between the object OB8 and the object OB9 based on the fact that the relative positions in the X-axis direction between the fingertip F of the index finger and the fingertip T of the thumb is switched as illustrated in Step S53. The wearable device 1 changes the positions of the object OB8 and the object OB9, and displays the object OB9 and the object OB8 to be separated from each other by a distance corresponding to the angle θ3. The wearable device 1 changes the display mode such that the object OB8 and the object OB9 are closer to each other as the angle θ increases when the angle θ is in the range of 0°≤θ≤90°, and changes the display mode such that the object OB8 and the object OB9 are separated father from each other as the angle θ increases when the angle θ is in the range of 90°≤θ≤180°. A virtual line v3 is not parallel to the reference line x in Step S53.

As described above, the controller 7 has the configuration of detecting the rotation angle (the change amount of angle θ) in a rotating body motion and changing the relative positions of the plurality of display images according to the rotation angle (the change amount of the angle θ) as the first process when detecting the rotating body motion in the wearable device 1 according to the present embodiment.

Although the configuration in which the relative positions of the plurality of display images are changed according to the change of the component in the predetermined direction of the distance between a part and the other part of the upper limb accompanying the rotating body motion or the rotation angle in the rotating body motion has been described in the sixth example, embodiments are not limited thereto. For example, the wearable device 1 may measure a duration time of a rotating body motion when detecting start of the rotating body motion and change a plurality of relative positions based on the duration time. The wearable device 1 may regard the rotating body motion as being started based on detection of approach of a part of the upper limb to the wearable device 1 by a first predetermined distance and separation of the other part of the upper limb from the wearable device 1 by a second predetermined distance.

Although the configuration of changing the front-and-back relationship or the display positions of the two display images based on the detection of the rotating body motion in the state where at least a part of the hand object OH is superimposed on at least one of the two display images has been exemplified in the third to sixth examples, embodiments are not limited to this configuration.

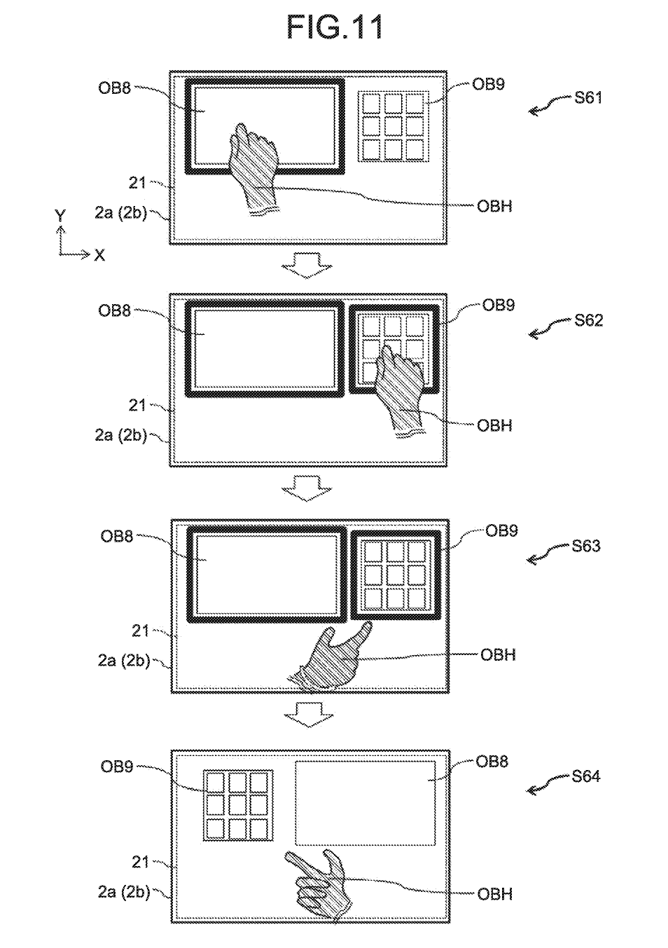

For example, the object OB8 is selected by bending the index finger in a state where the index finger of the hand object OBH is superimposed on the object OB8 (Step S61), and subsequently, the object OB9 is selected by bending the index finger in a state where the index finger of the hand object OBH is superimposed on the object OB9 (Step S62) as illustrated in FIG. 11. When a rotating body motion is performed in a state where the hand objects OBH is not superimposed on the objects OB8 and OB9 in the state of selecting the objects OB8 and OB9 (Step S63), the wearable device 1 switches the display positions of the object OB8 and the object OB9 based on detection of the rotating body motion (Step S64).

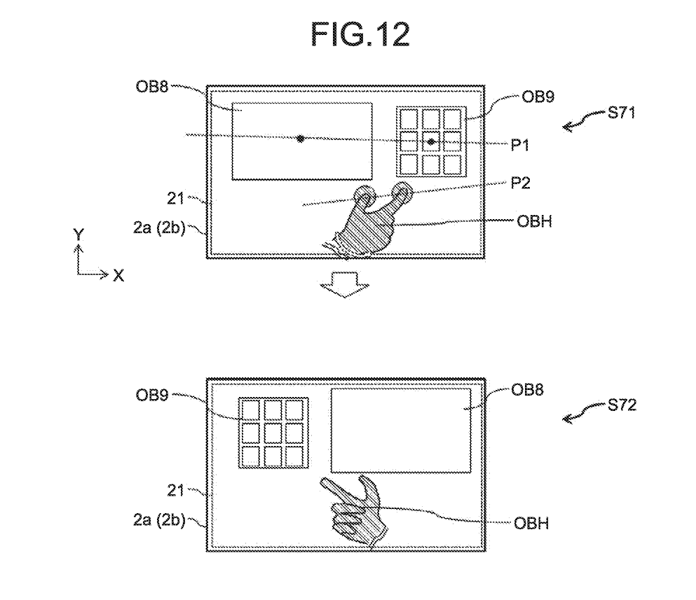

As illustrated in FIG. 12, the wearable device 1 recognizes a direction P1 defined by the display position of the object OB8 and the display position of the object OB9 in advance (Step S71). In the example illustrated in FIG. 12, the direction P1 is defined by a virtual line passing through a predetermined position (for example, a coordinate position of the center) of the object OB8, a predetermined position (a coordinate position of the center) of the object OB9 corresponding thereto. Further, when detecting the rotating body motion of the upper limb in a state where the index finger and the thumb of the hand object OBH are stretched, the wearable device 1 detects a direction P2 defined by a virtual line passing through the fingertip of the index finger and the fingertip of the thumb in the hand object OBH that is immediately before performing the rotating body motion. Further, the wearable device 1 determines whether an angle formed between the direction P1 and the direction P2 falls within a predetermined range, and switches the display positions of the object OB8 and the object OB9 when determining that the angle falls within the predetermined range (Step S72). With such a configuration as well, it is possible to change the front-and-back relationships or the display positions of the plurality of display images without superimposing the upper limb on the display image. The predetermined range of the angle may be defined to, for example, a range of being smaller than 30°.

For example, the wearable device 1 may decompose each of the directions P1 and P2 into components of the X-axis direction and components of the Y-axis direction instead of comparing the direction P1 and the direction P2, and change the front-and-back relationships or the display positions of the plurality of display images based on the rotating body motion when one direction with larger components coincides therebetween. The components of the X-axis direction are larger than the components of the Y-axis direction in both the directions P1 and P2 in the example of FIG. 12, and thus, the controller 7 determines that the detected rotating body motion is valid as an operation for the first process.

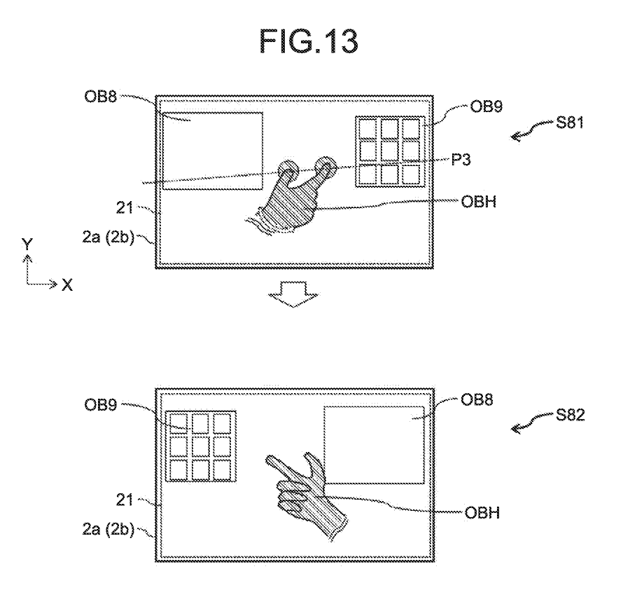

As illustrated in FIG. 13, when detecting the rotating body motion of the upper limb in the state where the index finger and the thumb of the hand object OBH are stretched, the wearable device 1 generates a virtual line P3 passing through the fingertip of the index finger and the fingertip of the thumb in the hand object OBH that is immediately before performing the rotating body motion (Step S81). Further, the wearable device 1 determines whether the virtual line P3 can pass through both the object OB8 and the object OB9, and switches the display positions of the object OB8 and the object OB9 when determining that the virtual line P3 can pass through both the objects (Step S82). With such a configuration as well, it is possible to change the front-and-back relationships or the display positions of the plurality of display images without superimposing the upper limb on the display image.

Although the configuration of changing the relative positions of the plurality of display images has been exemplified as the configuration of executing the display control different according to the rotation angle in rotating body motion in the sixth example, embodiments are not limited thereto.

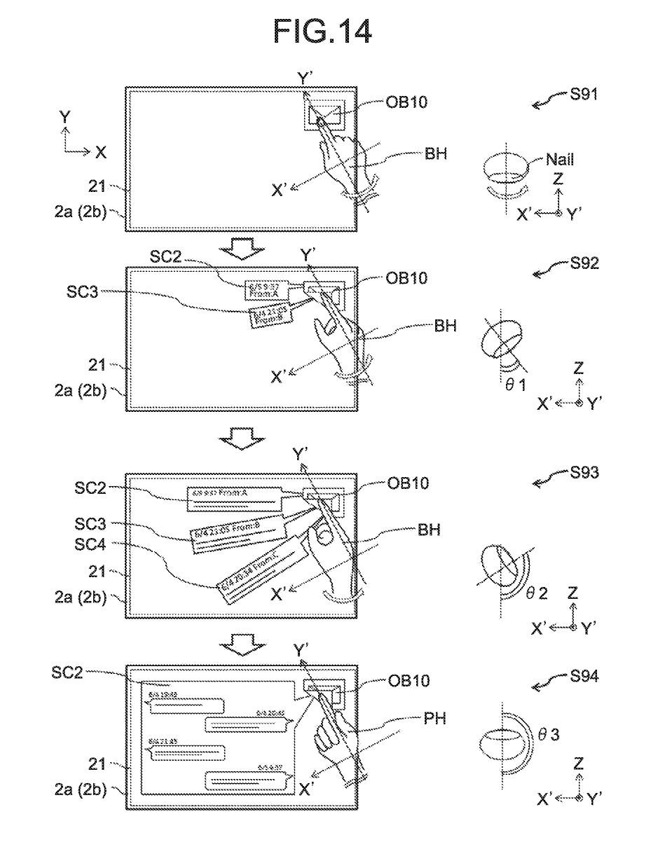

FIG. 14 is a view for describing a seventh example of the function executed by the wearable device 1. A region (corresponding to the X-Y plane in FIG. 3) that can be visually recognized by the user in a two-dimensional manner is illustrated on the left side in FIG. 14, and the back side BH of the user's right hand is caused to face the user side. At this time, the index finger of the hand BH is in a stretched state, and a stretching direction of the index finger is defined as a Y′-axis, and a direction perpendicular to the Y′-axis direction is defined as an X′-axis (it is assumed that an X′-Y′ plane is a plane substantially parallel to the X-Y plane). A view of the index finger when the fingertip of the index finger is viewed from an upper side of the Y′ axis is illustrated on the right side in FIG. 14.

In Step S91, the wearable device 1 displays an icon OB10 indicating that a mail function can be executed by the user's selection and execution operation in the display region 21 of the display unit 2. In Step S91, the wearable device 1 regards the icon OB10 as being selected by the user based on the superimposition of the fingertip of the index finger of the hand BH in a display range of the icon OB10. The wearable device 1 estimates the range of the real space that is recognized by the user in the state of being superimposed on the display region 21 in advance, and thus, it is possible to estimate which position of the display region 21 is superimposed and visually recognized according to a detected position of the index finger within the range.

Further, when the user rotates the forearm by a first predetermined angle θ1 about the stretching direction of the index finger (rotation in a direction indicated by the dotted-line arrow in FIG. 14, that is, supination) in the state illustrated in Step S91, that is, in the state where the icon OB10 is selected, the state transitions to a state illustrated in Step S92. The wearable device 1 detects the first rotation angle θ1 when detecting that the rotating body motion has been performed. The wearable device 1 regards the operation of executing the function associated with the icon OB10 as being performed by the user based on the detection of the rotating body motion, and starts to execute the function (Step S92). In Step S92, the wearable device 1 displays execution screens SC2 and SC3 of the function in the display unit 2 along with the execution of the function associated with the icon OB10. The execution screens SC2 and SC3 are images indicating simple information in an exchange of the latest mail for each mail partner.

When the user rotates the forearm by a second predetermined angle θ2, larger than the first predetermined angle θ1, from the state illustrated in Step S92, the state transitions to a state illustrated in Step S93. In Step S93, the wearable device 1 displays the execution screens SC2 and SC3 having more detailed information amount (for example, a part of mail statements is newly added) than the execution screens SC2 and SC3 in the case of the first predetermined angle θ1 and larger images in the display unit 2 based on a fact that the rotation angle in rotating body motion has reached the second predetermined angle θ2 larger than the first predetermined angle θ1. The wearable device 1 displays an execution screen SC4 on the display unit 2 in addition to the execution screens SC2 and SC3 based on the fact that the rotation angle in the rotating body motion has reached the second predetermined angle θ2 larger than the first predetermined angle θ1. For example, the execution screen SC4 is an image indicating information on an exchange of the latest mail with a mail partner different from the mail partners on the execution screens SC2 and SC3.

When the user rotates the forearm by a third predetermined angle θ3, larger than the second predetermined angle θ2, from the state illustrated in Step S93, the state transitions to a state illustrated in Step S94. In Step S94, the wearable device 1 displays the execution screen SC2 having more detailed information amount (for example, a screen on which past mail contents can be viewed) than the execution screen SC2 in the case of the second predetermined angle θ2 or a larger image in the display unit 2 based on a fact that the rotation angle in rotating body motion has reached the third predetermined angle θ3 larger than the second predetermined angle θ2. When displaying the execution screen SC2 having the larger image than the execution screen SC2 in the case of the second predetermined angle θ2, the execution screens SC3 and SC4 are not displayed.

As described above, the controller 7 detects a rotation angle in a rotating body motion when detecting the rotating body motion and executes a process according to the rotation angle as the first process in the wearable device 1 according to the present embodiment. Further, the controller 7 has the configuration of displaying at least one other image (the execution screen SC in the seventh example) relating to the display image and changing the information amount included in the other image, a size of the other image, or the number of the other images according to the rotation angle as the first process.

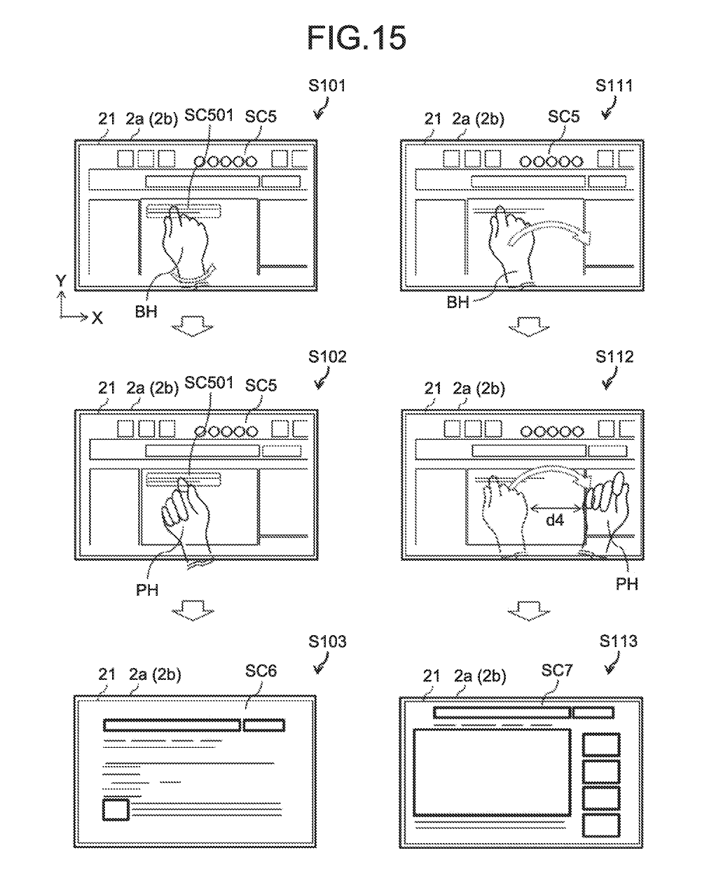

FIG. 15 is a view for describing an eighth example of the function executed by the wearable device 1. A region (corresponding to the X-Y plane in FIG. 3) that can be visually recognized by the user in a two-dimensional manner is illustrated in FIG. 15, and the back side BH of the user's right hand is caused to face the user side. The wearable device 1 displays a web browser screen SC5 in the display region 21 of the display unit 2. Two operation examples including a first operation example illustrated in Steps S101 to S103 and a second operation example illustrated in Steps S111 to S113 are illustrated together in FIG. 15.

First of all, the user superimposes the index finger of the hand BH on a predetermined character string SC501 on the screen SC5 and bends the index finger in the first operation example as illustrated in Step S101. The wearable device 1 recognizes that the predetermined character string on the screen SC5 is selected by the user by detecting a position of the index finger of the hand BH in the real space and the bending of the index finger.

When the user rotates the forearm (rotation in a direction indicated by the dotted-line arrow in FIG. 15, that is, supination) in the state illustrated in Step S101, that is, in the state where the character string SC501 is selected, the wearable device 1 detects that the rotating body motion has been performed and determines whether movement of the position of the upper limb by a predetermined length or longer is included. When the wearable device 1 determines that the position of the upper limb after performing the rotating body motion does not change as compared with the state in Step S101, that is, that the movement of the position of the upper limb by the predetermined length or longer is not included as illustrated in Step S102, the wearable device 1 causes display to transition to another web browser screen SC6 corresponding to the character string SC501 that has been selected by the user based on such determination, for example, as illustrated in Step S103.

On the other hand, the user performs a rotating body motion along with the movement of the upper limb as illustrated in Step S112 from a state where the hand BH is superimposed on a predetermined position on the screen SC5 in the second operation example as illustrated in Step S111. When the user rotates the forearm (rotation in the direction indicated by the dotted-line arrow in FIG. 15, that is, supination), the wearable device 1 detects that the rotating body motion has been performed and determines whether the rotating body motion includes the movement of the position of the upper limb by the predetermined length or longer. Further, when detecting a rotating body motion including movement by a distance d4 as the movement of the position of the upper limb by the predetermined length or longer, the wearable device 1 causes display to transition to another web browser screen SC7 instead of transition to the web browser screen SC6, as display control contents different from those of the first operation example, as illustrated in Step S113.

As described above, the controller 7 has the configuration of determining whether a rotating body motion is a first rotating body motion, which includes the movement of the position of the upper limb by the predetermined length or longer, or a second rotating body motion, which does not include the movement of the position of the upper limb by the predetermined length or longer, when detecting the rotating body motion, and varying the control contents between a predetermined process that is based on the first rotating body motion and a predetermined process that is based on the second rotating body motion, in the wearable device 1 according to the present embodiment.

Although the configuration in which the wearable device 1 executes predetermined display control, as a predetermined operation, based on detection of the rotating body motion has been exemplified in the respective examples above, the predetermined operation is not limited to the display control.

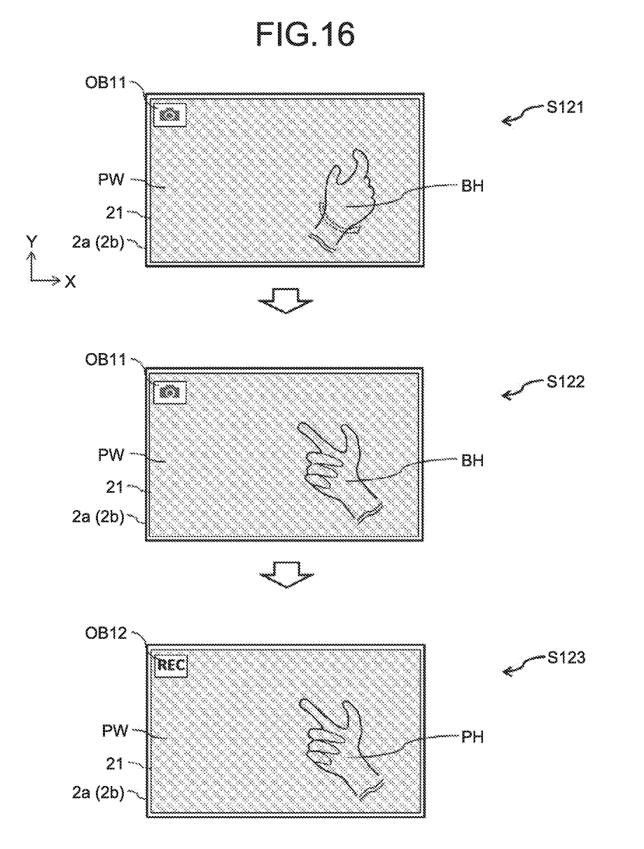

FIG. 16 is a view for describing a ninth example of the function executed by the wearable device 1. A region (corresponding to the X-Y plane in FIG. 3) that can be visually recognized by the user in a two-dimensional manner is illustrated in FIG. 16. In addition, the wearable device 1 activates an imaging function and displays captured images sequentially captured by the imager 3 on the display unit 2 as a preview window PW in the ninth example.

In Step S121, the user moves the right hand H to the front of the wearable device 1 and causes the back side of the right hand H to face the wearable device 1. As the back side of the right hand H is imaged by the imager 3, the back side BH of the right hand H is displayed in the preview window PW.

When the user rotates forearm in front of the wearable device 1 (rotation in a direction indicated by the dotted-line arrow in FIG. 16, that is, supination) while viewing the preview window PW (Step S122), the wearable device 1 detects that the rotating body motion has been performed by analyzing the captured image. Further, the wearable device 1 changes processing contents in the imaging function as the predetermined process by being triggered by the detection of the rotating body motion. The wearable device 1 performs a change from an imaging mode of a still image to an imaging mode of a moving image by being triggered by the detection of the rotating body motion as illustrated in Step S123. Along with this, the display is changed to an object OB12 indicating the imaging mode of the moving image in Step S123 while displaying an object OB11 indicating the imaging mode of the still image in the Step S121. A type of the imaging function to be changed based on the rotating body motion is not limited thereto, and it may be configured such that a correction value in exposure correction, ISO sensitivity, white balance, shutter speed, an aperture value, a depth of field, a focal length, a zoom ratio, and the like, for example, are changed, as various setting values relating to the imaging function, based on the rotating body motion. It may be also configured such that various setting values relating to the imaging function are changed in a continuous or stepwise manner based on the number of repetitions of the rotating body motion.

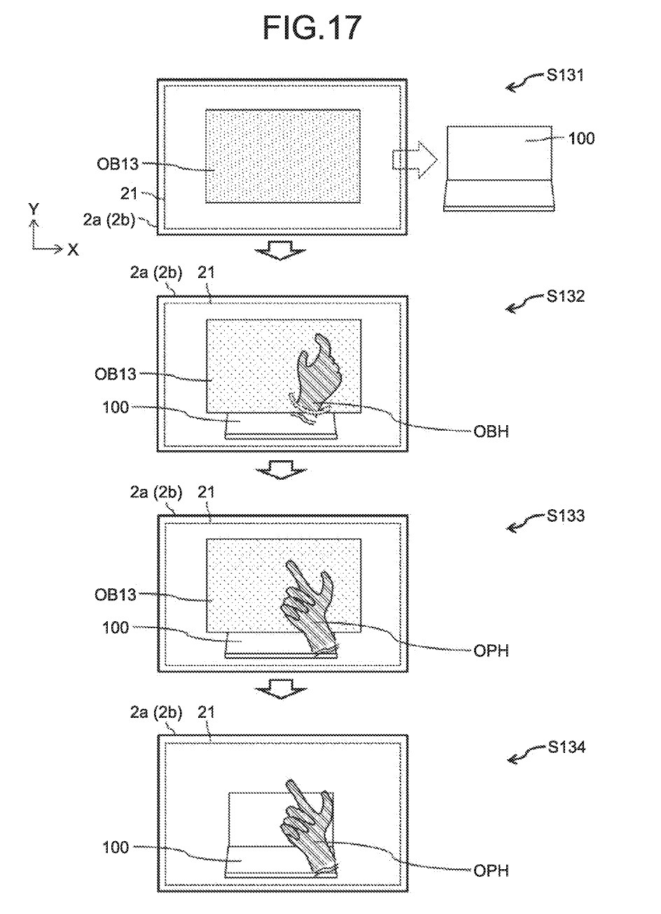

FIG. 17 is a view for describing a tenth example of the function executed by the wearable device 1. A region (corresponding to the X-Y plane in FIG. 3) that can be visually recognized by the user in a two-dimensional manner is illustrated in FIG. 17.

In Step S131, the wearable device 1 displays a display image OB13 on the display unit 2. In Step S131, a laptop computer 100 is located at a position that is close to the user or that can be visually recognized easily as another electronic device.

As changing an orientation of the head, for example, in the state the wearable device 1 is attached to the user in Step S131, the user transitions to a state of visually recognizing the laptop computer 100 through the display region 21 of the wearable device 1 (Step S132). At this time, the wearable device 1 determines that the laptop computer 100 is present in front of the wearable device 1 based on the detection result of the detector 5 or the captured image of the imager 3. In Step S132, the user visually recognizes that the display image OB13 is superimposed on the laptop computer 100. A case where it is difficult to visually recognize the laptop computer 100 in a region where the display image OB13 is opaque and the display image OB13 and the laptop computer 100 are superimposed on each other is exemplified, but the display image OB13 may be transparent or translucent. In this case, it is easy for the user to visually recognize the laptop computer 100 through the display image OB13.

As the user moves the upper limb within the detection range of the detector 5 of the wearable device 1 and causes the back side of the hand of the upper limb to face the detector 5 in Step S132, the wearable device 1 displays the hand object OBH having substantially the same shape as the shape of the upper limb and representing the back side of the hand of the upper limb on the display unit 2.

When the hand object OBH is inverted (Step S133) as the user rotates the forearm (rotation in a direction indicated by the dotted-line arrow in FIG. 17, that is, supination) in a state where at least a part of the hand object OBH is superimposed on the display image OB13 in Step S132, the wearable device 1 detects that the rotating body motion has been performed. Further, the wearable device 1 does not display the display image OB13 based on the detection of the rotating body motion (Step S134).

As described above, the controller 7 has the configuration in which whether there is another display device in front of the wearable device 1 is determined, and the display image is not displayed if detecting the rotating body motion when another display device is present in front of the wearable device 1, in the wearable device 1 according to the present embodiment. With such a configuration, when the visual recognition of display contents or the like of the display device is hindered by the display image displayed by the wearable device 1, it is possible to promptly solve such a hindered state with a simple operation by the user.

When determining whether the laptop computer 100 is present in front of the wearable device 1, the wearable device 1 may determine that the laptop computer 100 is present in front of the wearable device 1 based on detection of a part or the whole of the laptop computer 100 in the detection range 51 of the detector 5 or the imaging range of the imager 3, or may determine that the laptop computer 100 is present in front of the wearable device 1 based on detection of a part or the whole of the laptop computer 100 in a predetermined range (for example, a range of about 30 degrees of a view angle that is easy to enter the user's field of view) set in advance in the detection range 51 or the imaging range.

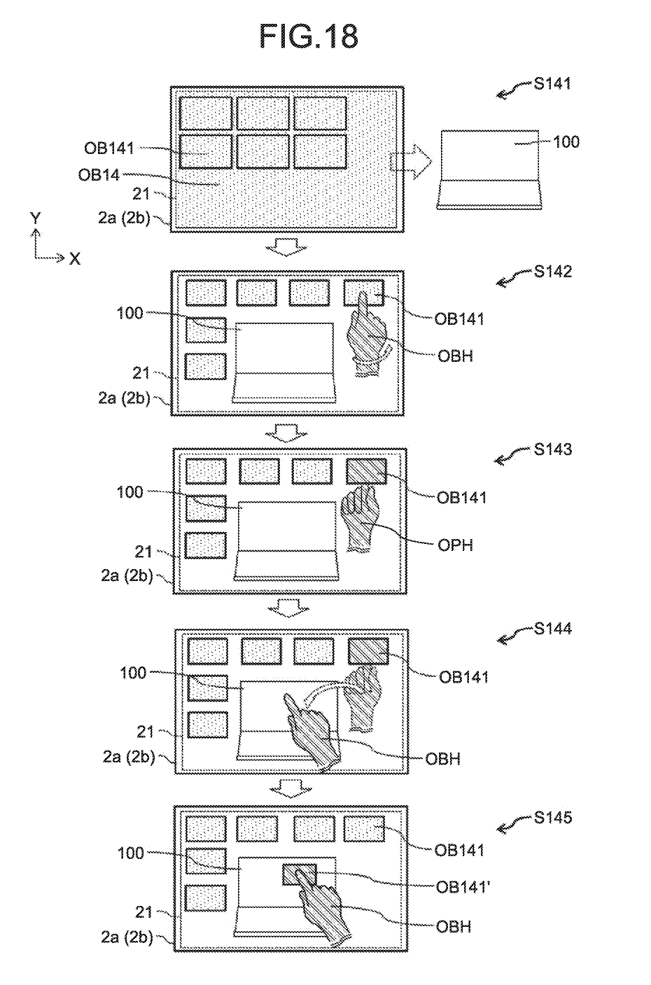

FIG. 18 is a view for describing an eleventh example of the function executed by the wearable device 1. The eleventh example is an example in which the wearable device 1 executes a predetermined communication process with another display device based on the user's body motion. A region (corresponding to the X-Y plane in FIG. 3) that can be visually recognized by the user in a two-dimensional manner is illustrated in FIG. 18.

In Step S141, the wearable device 1 displays an image list OB14 in which a plurality of display images including a display image OB141 is displayed in a list on the display unit 2. In Step S141, the laptop computer 100 is located at a position that is close to the user or that can be visually recognized easily as another electronic device.

When transitioning to the state of visually recognizing the laptop computer 100 through the display region 21 (Step S142) as the user wearing the wearable device 1 changes the orientation of the head in Step S141, the wearable device 1 determines that the laptop computer 100 is present in front of the wearable device 1 based on the detection result of the detector 5 or the captured image of the imager 3. Further, the wearable device 1 changes display modes of the plurality of display images that has been displayed in the list in the image list OB14 based on the fact that it is determined that the laptop computer 100 is present in front of the wearable device 1, and rearrange and display the respective display images at positions in such a manner as not to be superimposed on the laptop computer 100 or to be superimposed on the laptop computer 100 and thus not to be visually recognized in the display region 21, for example, as illustrated in Step S142.

As the user moves the upper limb within the detection range of the detector 5 of the wearable device 1 and causes the back side of the hand of the upper limb to face the detector 5 in Step S142, the wearable device 1 displays the hand object OBH having substantially the same shape as the shape of the upper limb and representing the back side of the hand of the upper limb on the display unit 2.

When the hand object OBH is inverted (Step S143) as the user rotates the forearm (rotation in a direction indicated by the dotted-line arrow in FIG. 18, that is, supination) in a state where at least a part of the hand object OBH is superimposed on a display image OB151 in Step S142, the wearable device 1 detects that the rotating body motion has been performed. Further, the wearable device 1 regards the display image OB141 as being selected by the user based on detection of the rotating body motion, and changes the display mode of the display image OB141. The wearable device 1 changes the display mode such that the display image OB141 is located in front of the hand OPH that is after performing the rotating body motion.

When a position of a fingertip is moved to a region superimposed on a display unit of the laptop computer 100 in the display region 21 (Step S144) while rotating the forearm (rotation in a direction indicated by the dotted-line arrow in FIG. 18, that is, pronation), that is, while performing the rotating body motion in a state where the user superimposes at least a part (the fingertip) of the hand OPH on the display image OB141 in the state illustrated in Step S143, the wearable device 1 determines that the user has performed an operation to transfer image data corresponding to the display image OB141 to the laptop computer 100. The wearable device 1 establishes wireless communication connection with the laptop computer 100 and transmits the image data to the laptop computer 100. As illustrated in Step S145, the laptop computer 100 displays a display image OB141′ having the same contents as the display image OB141 on the display unit 2 based on an image signal received from the wearable device 1.

As described above, the wearable device 1 according to the present embodiment includes the communication unit 8 that communicates with another electronic device, and the controller 7 has the configuration of determining whether there is another display device in front of the wearable device 1 and executing a second process including the data transferring process via communication with the other electronic device as the predetermined process when detecting the rotating body motion in a case where the other display device is present in front of the wearable device 1.

The wearable device 1 may detect a position that is after movement when detecting the movement of at least a part (fingertip) of the hand OPH from a position superimposed on the display image OB141 to a region superimposed on the display unit 2 of the laptop computer 100 in the display region 21 along with the rotating body motion, and control the laptop computer 100 in such a manner as to display the display image OB141′ at a position superimposed on or a position in the vicinity of the detected position.

When at least a part (fingertip) of the hand OPH is moved from the position superimposed on the display image OB141 to the region superimposed on the display unit of the laptop computer 100 in the display region 21 without performing the rotating body motion, the wearable device 1 may determine that it is not the operation to transfer the image data corresponding to the display image OB141 to the laptop computer 100.

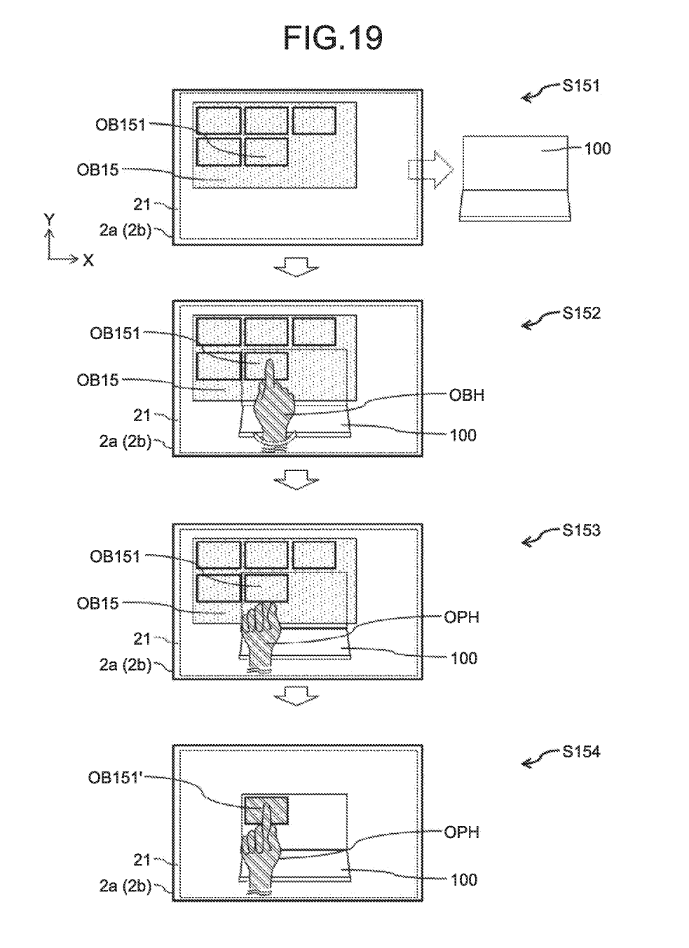

FIG. 19 is a view for describing a twelfth example of the function executed by the wearable device 1. The twelfth example is an example in which the wearable device 1 executes a predetermined communication process with another display device based on the user's body motion, which is similar to the eleventh example. A region (corresponding to the X-Y plane in FIG. 3) that can be visually recognized by the user in a two-dimensional manner is illustrated in FIG. 19.

In Step S151, the wearable device 1 displays an image list OB15 in which a plurality of display images including a display image OB151 are displayed in a list on the display unit 2. In Step S151, the laptop computer 100 is located at a position that is close to the user or that can be visually recognized easily as another electronic device.

When transitioning to the state of visually recognizing the laptop computer 100 through the display region 21 (Step S152) as the user wearing the wearable device 1 changes the orientation of the head in Step S151, the wearable device 1 determines that the laptop computer 100 is present in front of the wearable device 1 based on the detection result of the detector 5 or the captured image of the imager 3.

As the user moves the upper limb within the detection range of the detector 5 of the wearable device 1 and causes the back side of the hand of the upper limb to face the detector 5 in Step S152, the wearable device 1 displays the hand object OBH having substantially the same shape as the shape of the upper limb and representing the back side of the hand of the upper limb on the display unit 2.

When the hand object OBH is inverted (Step S153) as the user rotates the forearm (rotation in a direction indicated by the dotted-line arrow in FIG. 19, that is, supination) in a state where at least a part of the hand object OBH is superimposed on the display image OB151 in Step S152, the wearable device 1 detects that the rotating body motion has been performed. Further, when detecting the rotating body motion, the wearable device 1 determines whether at least a part of the display image OB151 on which at least a part of the hand object OBH has been superimposed by the user is superimposed on the display unit of the laptop computer 100, and regards the operation to transfer the image data corresponding to the display image OB151 to the laptop computer 100 as being performed by the user when determining that at least a part of the display image OB151 is superimposed on the display unit of the laptop computer 100. Further, the wearable device 1 establishes wireless communication connection with the laptop computer 100 and transmits the image data to the laptop computer 100. As illustrated in Step S154, the laptop computer 100 displays a display image OB151′ having the same contents as the display image OB151 on the display unit 2 based on an image signal received from the wearable device 1.

When detecting the rotating body motion, the wearable device 1 determines whether at least a part of the display image OB151 on which at least a part of the hand object OBH has been superimposed by the user is superimposed on the display unit of the laptop computer 100, and regards the operation to transfer the image data corresponding to the display image OB151 to the laptop computer 100 as not performed when determining that at least a part of the display image OB151 is not superimposed on the display unit of the laptop computer 100.

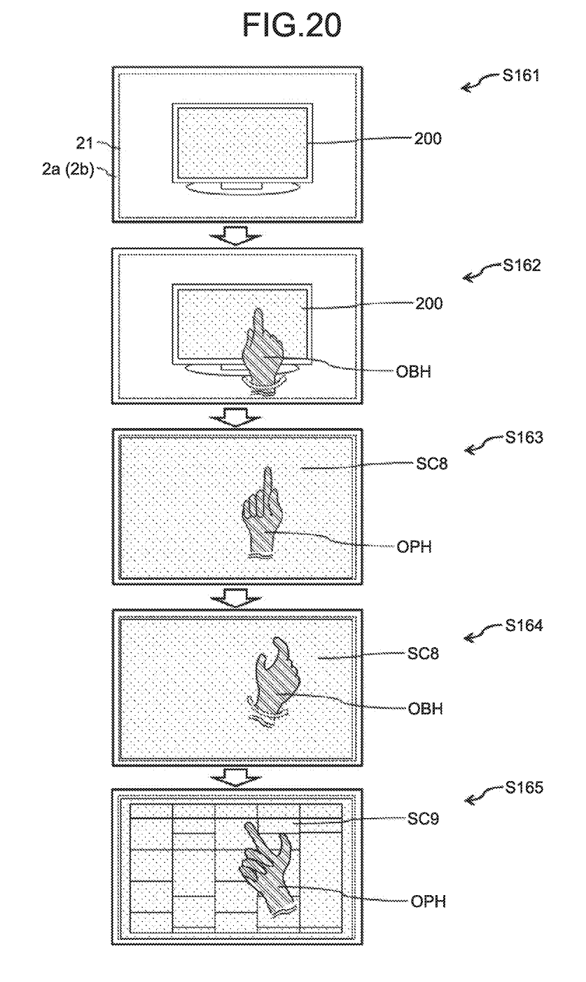

FIG. 20 is a view for describing a thirteenth example of the function executed by the wearable device 1. The thirteenth example is an example in which the wearable device 1 executes a predetermined communication process with another display device based on the user's body motion, which is similar to the eleventh example and the twelfth example. A region (corresponding to the X-Y plane in FIG. 3) that can be visually recognized by the user in a two-dimensional manner is illustrated in FIG. 20.

In Step S161, the user visually recognizes a television 200 as another electronic device through the display region 21 of the display unit 2. The user is watching a video displayed on the television 200 through the display region 21 of the display unit 2.

As the user moves the upper limb within the detection range 51 of the detector 5 of the wearable device 1 and causes the back side of the hand of the upper limb to face the detector 5 in Step S162, the wearable device 1 displays the hand object OBH having substantially the same shape as the shape of the upper limb and representing the back side of the hand of the upper limb on the display unit 2.

In Step S162, when the hand object OBH is inverted (Step S162) as the user rotates the forearm (rotation in a direction indicated by the dotted-line arrow in FIG. 20, that is, supination), the wearable device 1 detects that the rotating body motion has been performed. Then, when detecting the rotating body motion, the wearable device 1 determines whether the rotating body motion has been performed in a state where at least a part of the hand object OBH is superimposed on the television 200 or a display unit of the television 200 in the front- and-back direction of the wearable device 1 or a direction in which the hand object OBH intersects the X-Y plane at a predetermined angle. That is, the wearable device 1 determines whether the rotating body motion has been detected in a state where the user has specified the television 200 or a video displayed by the television 200.

When determining that the rotating body motion has been detected in a state where the television 200 or the video displayed by the television 200 has been specified by the user, that is, that the rotating body motion has been performed in a state where at least a part of the hand object OBH is superimposed on the television 200 or the video displayed by the television 200, the wearable device 1 establishes wireless communication connection with the television 200 and performs a transmission request of image data to the television 200. When receiving the transmission request of the image data from the wearable device 1, the television 200 transmits the image data corresponding to the video displayed by the television 200 to the wearable device 1. The wearable device 1 causes the display unit 2 to display a video SC8, which is the same as the video displayed by the television 200, based on the image data received from the television 200 (Step S163). The wearable device 1 may recognize, in advance, that a transmission request destination of the image data is the television 200 according to the setting by the user at the time that is before detecting the rotating body motion.

Subsequently, the user changes a shape of the hand object OBH in the state (Step S163) where an operation for displaying the video SC8 on the display unit 2 of the wearable device 1 has been completed. When the forearm is rotated in the changed state (Step S164), the display is switched to a code list SC9 that the television 200 can receive broadcasting as an image different from the video SC8 (Step S165).

Although embodiments according to the present application have been described above, it should be noted that those skilled in the art can easily make various modifications and corrections based on the present disclosure. Therefore, it should be noted that these modifications and corrections are included in the scope of the present application. Further, all the technical matters disclosed in the present specification can be rearranged so as not to conflict, and it is possible to combine a plurality of components into one or divide the plurality of components.

The multiple examples of the functions executed by the wearable device 1 have been illustrated with reference to the above-described respective examples. Although the description has been given in each example by applying any case between the configuration of performing the operation while visually recognizing the upper limb existing in the real space without displaying the object OH as in the first example and the configuration of performing the operation while visually recognizing the object OH by displaying the object OH as in the second example, it should be noted that embodiments are not limited to either case. It is a matter of course that both the configuration of performing the operation while visually recognizing the upper limb existing in the real space without displaying the object OH and the configuration of performing the operation while visually recognizing the object OH by displaying the object OH can be applied in all the examples of the functions executed by the wearable device 1 described above.

Although the configuration of changing the front-and-back relationship or the display positions of the two display images as the change of the display modes of the two display images based on the detection of the rotating body motion has been exemplified in the above-described third to sixth examples, the contents of the display mode change are not limited thereto. For example, the wearable device 1 may perform reduced display or non-display of one of two display images and enlarged display of the other display image based on the detection of the rotating body motion.

The configuration in which the wearable device 1 executes the predetermined operation based on the detection of the rotating body motion accompanying the rotation of the arm in the upper limb among the body motions, or determines the first state where the upper limb included in the captured image captured by the imager 3 (or the infrared imager as the detector 5) is the palm side or the second state as the back side of the hand and executes the predetermined operation by being triggered by the detection of the rotating body motion accompanying inversion from one of the first state and the second state to the other state has been exemplified in the above-described respective examples. Although the case where the upper limb is a right upper limb has been exemplified in all the examples, embodiments are not limited thereto, and the upper limb may be a left upper limb. The upper limb may be both the right upper limb and the left upper limb. Further, the wearable device 1 may have a configuration of executing the predetermined process exemplified in each of the above-described examples based on the detection of a specific body motion accompanying both the motion in which a part of the upper limb (for example, the right upper limb) is separated from the wearable device 1 and a motion in which the other part of the upper limb (for example, the left upper limb) approaches the wearable device 1 from the detection result of the detector 5. For example, assuming that the user has performed a motion of pulling the left hand to the user side while simultaneously stretching out the right hand to the front as the specific body motion, the wearable device 1 may regard this motion as the same body motion as the above-described rotating body motion and execute the above-described various predetermined operations.

Although the example where the wearable device 1 executes the first process relating to the display image, the second process including the data transferring process via the communication with the other electronic device, the change of the imaging function, or the like as the predetermined process based on rotating body motion has been illustrated in the above-described respective examples, the examples of the predetermined process are not limited thereto. For example, when a character is input by a predetermined operation of the user and the character is displayed on the display unit 2, the wearable device 1 may execute Kana/Kanji conversion of the input character, Japanese/English translation, conversion to a prediction candidate that is predicted based on the input character, and the like as the predetermined process based on the detection of the rotating body motion. The wearable device 1 may sequentially change conversion candidates in the Kana/Kanji conversion based on the number of repetitions of the detected rotating body motion. Similarly, the wearable device 1 may sequentially change candidates of translated words in the Japanese/English translation, the predicted candidates predicted based on the input character, or the like based on the number of repetitions of the detected rotating body motion.

Although the example in which the wearable device 1 has the glasses shape has been described in the above-described examples, but the shape of the wearable device 1 is not limited thereto. For example, the wearable device 1 may have a helmet shape that covers substantially the upper half of the user's head. Alternatively, the wearable device 1 may have a mask shape that covers substantially the entire face of the user.

Although the configuration in which the display unit 2 has the pair of display units 2a and 2b provided in front of the user's right and left eyes has been exemplified in the above-described examples, embodiments are not limited thereto, and the display unit 2 may have a single display unit provided in front of one of the user's right and left eyes.

Although the configuration in which an edge of a front portion surrounds the entire circumference of an edge of the display region of the display unit 2 has been exemplified in the above-described examples, embodiments are not limited thereto. It may be configured such that only a part of the edge of the display region of the display unit 2 is surrounded by the edge of the front portion.

Although the configuration in which the hand and/or finger is detected by the imager (or the detector) as the user's upper limb has been illustrated in the above examples, the hand and/or finger can be detected in the same manner even in the state of wearing a glove, a glove, or the like.

Although the configuration and operation of the wearable device 1 have been described in the above examples, embodiments are not limited thereto but may be configured as a method or a code including the respective components.

1. A wearable device attachable to a head, comprising:
a detector configured to be capable of detecting an upper limb of a user existing in a real space; and
a controller configured to execute a predetermined process based on detection of a rotating body motion accompanying rotation of an arm in the upper limb from a detection result of the detector.

2. The wearable device according to claim 1, further comprising
a display unit configured to display a display image in front of an eye of the user,
wherein the controller executes a first process relating to the display image as the predetermined process.

3. The wearable device according to claim 1, wherein
the controller executes the predetermined process based on detection of a body motion accompanying one of a pronation motion and a supination motion of the arm as the rotating body motion, and
ends the predetermined process based on detection of a body motion accompanying the other motion of the pronation motion and the supination motion during the execution of the predetermined process.

4. The wearable device according to claim 1, wherein
the controller executes the predetermined process based on detection of a body motion accompanying one of a pronation motion and a supination motion of the arm as the rotating body motion, and
executes a second process containing control contents forming a pair with the predetermined process based on detection of a body motion accompanying the other motion of the pronation motion and the supination motion within a predetermined time after execution of the predetermined process.

5. The wearable device according to claim 2, wherein
the controller executes the first process on the display image selected based on a position of the upper limb at a time that is before detection of the rotating body motion when detecting the rotating body motion.

6. The wearable device according to claim 2, wherein
the display unit displays a plurality of the display images, and
the controller executes the first process when detecting the rotating body motion in a state where the plurality of display images is specified.

7. The wearable device according to claim 6, wherein
the controller regards the plurality of display images as being specified based on presence of the upper limb at a predetermined position in the real space.

8. The wearable device according to claim 6, wherein
the controller executes the first process when detecting the rotating body motion in a state where a first display image among the plurality of display images is specified by one part of the upper limb and a second display image among the plurality of display images is specified by another part of the upper limb.

9. The wearable device according to claim 6, wherein
the controller changes front-and-back relationships of the plurality of display images as the first process.

10. The wearable device according to claim 6, wherein
the controller switches display positions of the plurality of display images as the first process.

11. The wearable device according to claim 8, wherein
the controller changes a relative position between the first display image and the second display image according to a change of a component in a predetermined direction of a distance between the one part and the other part accompanying the rotating body motion when detecting the rotating body motion.

12. The wearable device according to claim 6, wherein
the controller detects a rotation angle in the rotating body motion when detecting the rotating body motion and changes relative positions of the plurality of display images according to the rotation angle as the first process.

13. The wearable device according to claim 2, wherein
the controller detects a rotation angle in the rotating body motion when detecting the rotating body motion and executes a process according to the rotation angle as the first process.

14. The wearable device according to claim 13, wherein
the controller displays at least one other image relating to the display image and
changes information amount included in the other image,
a size of the other image, or
a number of the other images
according to the rotation angle as the first process.

15. The wearable device according to claim 2, wherein
the controller determines whether the rotating body motion is a first rotating body motion or a second rotating body motion, the first rotating body motion including movement of a position of the upper limb by a predetermined length or longer, the second rotating body motion not including the movement of the position of the upper limb by the predetermined length or longer, when detecting the rotating body motion and
varies control contents between the predetermined process based on the first rotating body motion and the predetermined process based on the second rotating body motion.

16. The wearable device according to claim 2, wherein
the controller does not display the display image as the first process.

17. The wearable device according to claim 16, wherein
the controller determines whether another display device is present in front of the wearable device and
does not display the display image when detecting the rotating body motion in a case where the other display device is present in front of the wearable device.

18. The wearable device according to claim 1, further comprising
a communication unit configured to communicate with another electronic device,
wherein the controller determines whether another display device is present in front of the wearable device and executes a second process including a data transferring process via communication with the other electronic device as the predetermined process when detecting the rotating body motion in a case where the other display device is present in front of the wearable device.

19-20. (canceled)

21. A control method executed by a wearable device, the wearable device comprising a detector configured to be capable of detecting an upper limb of a user existing in a real space and a controller and is attachable to a head, wherein
the controller executes a predetermined process based on detection of a rotating body motion accompanying rotation of an arm in the upper limb from a detection result of the detector.

22. A non-transitory computer readable recording medium therein a control code that causes a controller to execute a predetermined process in a wearable device, the wearable device comprising a detector configured to be capable of detecting an upper limb of a user existing in a real space and the controller and is attachable to a head, based on detection of a rotating body motion accompanying rotation of an arm in the upper limb from a detection result of the detector.
